(19) United States
(12) Patent Application Publication
(10) Pub. No.: US 2021/0292551 A1
(43) Pub. Date: Sep. 23, 2021

(54) THREE-DIMENSIONAL LATTICE STRUCTURES CONTAINING OPERATING MATERIAL, COMPOSITIONS COMPRISING THE SAME, AND COMPOSITIONS AND METHODS FOR MAKING THE SAME

(71) Applicant: James F. Brown, Clifton, VA (US)

(72) Inventor: James F. Brown, Clifton, VA (US)

(21) Appl. No.: 17/162,078

(22) Filed: Jan. 29, 2021

Related U.S. Application Data
(63) Continuation of application No. PCT/US2019/043405, filed on Jul. 25, 2019.
Application No. PCT/US2019/043405 is a continuation-in-part of application No. 16/049,008, filed on Jul. 30, 2018.
Application No. 16/049,008 is a continuation-in-part of application No. 16/270,011, filed on Feb. 7, 2019.

(51) Int. Cl. C08L 71/00; C08K 5/5419; C08K 5/12

(52) U.S. Cl. CPC C08L 71/00; C08K 5/5419; C08L 2203/16; C08L 2205/24; C08K 5/12

(57) ABSTRACT

Chemical structures that define cells in which operating material can be held, as well as compositions that contain such chemical structures and operating material, compositions for use in making such compositions, and methods for making all of the above. Compositions for use in making such chemical structures, comprising nuclear moiety precursor compounds and elongated moiety precursor compounds. Lattice structures comprising nuclear moieties (analogous to nodes) and elongated moieties (analogous to connectors extending between nodes). Articles comprising one or more of such compositions. Also, a structure that comprises a lattice structure/operating material region (comprising at least a first lattice structure (comprising a plurality of nuclear moieties and a plurality of elongated moieties) and at least a first operating material) and at least a first additional region.

### CROSS-REFERENCE TO RELATED APPLICATION

The present application is a continuation of International Application No. PCT/US2019/043405, the entirety of which is incorporated herein by reference. International Application No. PCT/US2019/043405 is a continuation-in-part of U.S. patent application Ser. No. 16/049,008 and a continuation-in-part of U.S. patent application Ser. No. 16/270,011.

The present application is also a continuation-in-part of U.S. patent application Ser. No. 16/049,008, filed Jul. 30, 2018 (U.S. Patent Application Publication No. publication no. 2020-0032073 (published on Jan. 30, 2020), and the present application claims the benefit of U.S. patent application Ser. No. 16/049,008, the entirety of which is incorporated herein by reference.

The present application is also a continuation-in-part of U.S. patent application Ser. No. 16/270,011, filed Feb. 7, 2019 (U.S. Patent Application Publication No. 2020/0032065 (published on Jan. 30, 2020) (and U.S. patent application Ser. No. 16/270,011 is a continuation-in-part of U.S. patent application Ser. No. 16/049,008, filed Jul. 30, 2018), and the present application claims the benefit of U.S. patent application Ser. No. 16/270,011, filed Feb. 7, 2019, the entirety of which is incorporated herein by reference.

### FIELD OF THE INVENTIVE SUBJECT MATTER

The present inventive subject matter relates to chemical structures that define cells in which operating material can be held, as well as compositions that contain such chemical structures and operating material, compositions for use in making such compositions, and methods for making all of the above. The present inventive subject matter further relates to structures that comprise [1] at least a first substrate (as described herein), [2] at least a first lattice structure/operating material region (which comprises at least one lattice structure as described herein and at least one operating material as described herein), and [3] at least a first additional region (as described herein) between the first substrate and the first lattice structure/operating material region, as well as methods for making such structures. The present inventive subject matter further relates to structures that comprise at least one lattice structure (as described herein) and at least one operating material (as described herein), as well as methods for making such structures. The present inventive subject matter further relates to structures that comprise at least one lattice structure (as described herein), at least one operating material (as described herein) and at least one additional region, as well as methods for making such structures.

### BACKGROUND

There is an ongoing need for materials (e.g., coatings, films, laminates and other structures) which have any of a variety of properties, including low adhesion, anti-fogging capabilities, fluid repellent capabilities, and self-cleaning capabilities, for use, e.g., in making a wide variety of products, e.g., as diverse as windows, sensors, biomedical devices and lenses. There is a need for materials (e.g., coatings, films, laminates and other structures) that have excellent release properties, and that can be used to make a wide variety of products, e.g., molds, transfer films, industrial tapes, labels, die-cut constructions, double-sided tapes, silicone foam or rubber tapes, in-process liners for easier handling of jumbo rolls, transfer to heat sensitive or non-solvent-castable backings, and non-adhesion lab and medical devices. There is also a need for materials (e.g., coatings, films, laminates and other structures) that have anti-stain capabilities, and/or anti-fingerprint capabilities, for use in making a wide variety of products, e.g., touch screens, small and large appliance bodies and working surfaces. There is also a need for materials (e.g., coatings, films, laminates and other structures) that can provide excellent ice release on wind turbines, power lines, building drip edges, fishing lines, and aircraft wings. There is also a need for materials that are effective as adhesives, including pressure-sensitive adhesives.

### BRIEF SUMMARY OF THE INVENTIVE SUBJECT MATTER

Polymers are large molecules (in most cases) with physical properties that depend on the interactions between the polymer chains. An important factor in these interactions is the topology of chains making up the backbone of the molecule.

Some polymer molecules are linear, similar to normal alkanes, such as n-decane. An example of a linear polymer is high density polyethylene (HDPE), which can contain more than 1,000 CH₂ groups. Polymers with very small pendant groups, such as the methyl group in polypropylene, are considered to be linear. Simulated skeletal and more detailed structures of HDPE are shown in FIGS. 1 and 2.

In many cases, linear polymers may form closely packed crystals, as figuratively shown in FIG. 3.

Some polymers, such as low density polyethylene (LDPE), have branches of different sizes irregularly spaced along the chain. Such polymers are said to be branched or nonlinear.

The branches prevent the nonlinear molecules from packing as closely as the linear molecules, thus reducing their density. Simulated skeletal and more detailed structures of LDPE are shown in FIGS. 4 and 5.

Some polymers have cross-links between polymer chains, creating networks, and are called network polymers. Slightly cross-linked polymers are often elastomers, while highly cross-linked polymers may be rigid and hard. Cross-links may be formed by exposure to heat, light, moisture, and/or oxygen, or by other chemical reactions. A skeletal structure of a network polymer with a high cross-link density is illustrated in FIG. 6.

In each of these cases, polymer topology also determines the degree to which additives and property modifiers may be taken up inside the structure. Crystalline linear polymers have almost no ability to hold slip agents and plasticizers inside their structure. Due to free space considerations, branched polymers may hold somewhat more. Depending on the degree of cross-linking, network polymers may hold considerably more of such liquid or solid agents than linear or branched polymers.

Of such agents, lubricants have been impregnated into materials for many centuries, when fats were soaked into fire-hardened axles and wheel races. Babbitt bearings are comprised of porous metals that absorb lubricants. Nylon 6,6 and PTFE bearings may contain liquid or solid lubricants that provide extended lubricity.

Shallow surface microstructures comprising oils were disclosed by Brown in U.S. Pat. No. 6,767,587. More recently, Aizenberg, et. al., disclosed in U.S. Pat. No. 9,630,224 surface structures to superficially retain lubricants and to provide reduced adhesion to ice and other substances. To the same end, Golovin, et. al., disclosed curing durable random network polymers comprising lubricants at modest levels of about 10 to 15 percent in PCT Publication No. WO 2016/176350 A1. Higher levels of lubricant may be expressed at the polymer surface.

In 1983, network polymers were disclosed by Von Au, et al., in U.S. Pat. No. 4,503,210, comprising components forming elastomers with the potential to form polymer crystalline lattices; however, the polymers were formed without essential ingredients and under conditions where such structures would never have formed. Much later, Miriani, et al., disclosed similar liquid rubber compositions in U.S. Pat. No. 9,528,005. These compositions comprised a novel solid filler. They also included low levels of silicone oils as plasticizers and diluents that would have been insufficient to form structures of the present invention.

In accordance with a first aspect of the present inventive subject matter, there is provided a composition, comprising:

at least a first lattice structure; and

at least a first operating material,

the first lattice structure comprising a plurality of nuclear moieties and a plurality of elongated moieties,

at least some of said nuclear moieties chemically bonded to at least three of said elongated moieties,

at least some of said elongated moieties chemically bonded to at least two of said nuclear moieties.

In some embodiments according to the first aspect of the present inventive subject matter, which can include or not include, as suitable, any of the other features described herein, at least some of said nuclear moieties correspond to (as defined herein) at least one compound selected from among the group of compounds consisting of 2-Butanone, O,O′,O″-silanetetrayltetraoxime, 2-Butanone,O,O′,O″-(Methylsilylidyne)Trioxime, Tetramethoxysilane, Tetraethoxysilane, Tetraethyl orthosilicates, Tetrachlorosilane, Trichlorosilane, Tungsten hexachloride, Molybdenum hexacarbonyl, 1,2 Bis(Triethoxysilyl)ethane, and 1,2 Bis(Triethoxysilyl)methane, Molybdenum (VI) oxide bis(pentanedionate, Molybdenum (VI) oxide bis(2,2,6,6-tetramethyl-3,5-heptanedionate, Tungsten (VI) phenoxide, methyltrimethoxysilane, chloromethyltrimethoxysilane, ethyltrimethoxysilane, propyltrimethoxysilane, vinyltrimethoxysilane, methyltriethoxysilane, vinyltriethoxysilane, phenyltriethoxysilane, methyltripropoxysilane, phenyltripropoxysilane, tetramethoxysilane, tetraethoxysilane, tetra-n-propoxysilane, tetra-n-butoxysilane, methyltris(methylethylketoxime)silane, phenyltris(methylethylketoxime)silane, vinyltris(methylethylketoxime)silane, methyltris(methylisobutylketoxime)silane, methyltris(methylpropylketoxime)silane, and tetra(methylethylketoxime)silane, and/or at least some of said elongated moieties correspond to (as defined herein) at least one compound selected from among the group of compounds consisting of silane-terminated polyethers (fluorinated in one or more location or not fluorinated), oxime-terminated polyethers (fluorinated in one or more location or not fluorinated), silane-terminated urethanes (fluorinated in one or more location or not fluorinated), oxime-terminated urethanes (fluorinated in one or more location or not fluorinated), silane-terminated alkyl polymers, silane-terminated aryl polymers, oxime-terminated alkyl polymers, oxime-terminated aryl polymers, and hydrophilic materials, such as poly(ethylene glycol) (PEG), low molecular weight poly(propylene glycol) (PPG).

In some embodiments according to the first aspect of the present inventive subject matter, which can include or not include, as suitable, any of the other features described herein, moieties selected from among moieties that correspond to (as defined herein) compounds selected from among the group consisting of 2-Butanone, O,O′,O″-silanetetrayltetraoxime, 2-Butanone,O,O′,O″-(Methylsilylidyne)Trioxime, Tetramethoxysilane, Tetraethoxysilane, Tetraethyl orthosilicates, Tetrachlorosilane, Trichlorosilane, Tungsten hexachloride, Molybdenum hexacarbonyl, 1,2 Bis(Triethoxysilyl)ethane, and 1,2 Bis(Triethoxysilyl)methane, Molybdenum (VI) oxide bis(pentanedionate, Molybdenum (VI) oxide bis(2,2,6,6-tetramethyl-3,5-heptanedionate, Tungsten (VI) phenoxide, methyltrimethoxysilane, chloromethyltrimethoxysilane, ethyltrimethoxysilane, propyltrimethoxysilane, vinyltrimethoxysilane, methyltriethoxysilane, vinyltriethoxysilane, phenyltriethoxysilane, methyltripropoxysilane, phenyltripropoxysilane, tetramethoxysilane, tetraethoxysilane, tetra-n-propoxysilane, tetra-n-butoxysilane, methyltris(methylethylketoxime)silane, phenyltris(methylethylketoxime)silane, vinyltris(methylethylketoxime)silane, methyltris(methylisobutylketoxime)silane, methyltris(methylpropylketoxime)silane, tetra(methylethylketoxime)silane, silane-terminated polyethers (fluorinated in one or more location or not fluorinated), oxime-terminated polyethers (fluorinated in one or more location or not fluorinated), silane-terminated urethanes (fluorinated in one or more location or not fluorinated), oxime-terminated urethanes (fluorinated in one or more location or not fluorinated), silane-terminated alkyl polymers, silane-terminated aryl polymers, oxime-terminated alkyl polymers, oxime-terminated aryl polymers, hydrophilic materials, such as poly(ethylene glycol) (PEG), and low molecular weight poly(propylene glycol) (PPG), account for at least 80 atomic percent of the first lattice structure.

In some embodiments according to the first aspect of the present inventive subject matter, which can include or not include, as suitable, any of the other features described herein, each of at least some of said nuclear moieties comprise at least one bonded-functional moiety corresponding to (as defined herein) at least one moiety selected from among the group of moieties consisting of silanes, silols, oximes, dendrites, polysilsesquioxanes, halogens, compounds with one or more hydrolysable groups, siloxanes, silicones, compounds with one or more acrylic groups, compounds with one or more methacrylic groups, compounds with one or more vinyl groups, isocyanates, amines, amides, active hydrogens, compounds with one or more hydroxyl groups, compounds with one or more sulfur groups, epoxies, organo-metallics, organo-silicones, sulfides, halides, phosphates, organic alcohols, inorganic alcohols, organic acids and inorganic acids. Correspondingly, representative examples of nuclear moiety functional moieties include chemical structures that correspond to any of such nuclear moiety precursor compound functional moieties, i.e., chemical structures that correspond to any of silanes, silols, oximes, dendrites, polysilsesquioxanes, halogens, compounds with one or more hydrolysable groups, siloxanes, silicones, compounds with one or more acrylic groups, compounds with one or more methacrylic groups, compounds with one or more vinyl groups, isocyanates, amines, amides, active hydrogens, compounds with one or more hydroxyl groups, compounds with one or more sulfur groups, epoxies, organo-metallics, organo-silicones, sulfides, halides, phosphates, organic alcohols, inorganic alcohols, organic acids and inorganic acids.

In some embodiments according to the first aspect of the present inventive subject matter, which can include or not include, as suitable, any of the other features described herein, each of at least some of said elongated moieties comprise at least one bonded-functional moiety corresponding to (as defined herein) at least one moiety selected from among the group of moieties consisting of silanes, silols, oximes, dendrites, polysilsesquioxanes, halogens, compounds with one or more hydrolysable groups, siloxanes, silicones, compounds with one or more acrylic groups, compounds with one or more methacrylic groups, compounds with one or more vinyl groups, isocyanates, amines, amides, active hydrogens, compounds with one or more hydroxyl groups, compounds with one or more sulfur groups, epoxies, organo-metallics, organo-silicones, sulfides, halides, phosphates, organic alcohols, inorganic alcohols, organic acids and inorganic acids. Correspondingly, representative examples of elongated moiety functional moieties include chemical structures that correspond to any of such elongated moiety precursor compound functional moieties, i.e., chemical structures that correspond to any of silanes, silols, oximes, dendrites, polysilsesquioxanes, halogens, compounds with one or more hydrolysable groups, siloxanes, silicones, compounds with one or more acrylic groups, compounds with one or more methacrylic groups, compounds with one or more vinyl groups, isocyanates, amines, amides, active hydrogens, compounds with one or more hydroxyl groups, compounds with one or more sulfur groups, epoxies, organo-metallics, organo-silicones, sulfides, halides, phosphates, organic alcohols, inorganic alcohols, organic acids and inorganic acids.

In some embodiments according to the first aspect of the present inventive subject matter, which can include or not include, as suitable, any of the other features described herein, at least some of the first operating material is in respective wells in the first lattice structure.

In some embodiments according to the first aspect of the present inventive subject matter, which can include or not include, as suitable, any of the other features described herein, the first operating material comprises at least one compound selected from among the group of compounds consisting of volatile and/or non-volatile oils, organic oils, silicone oils, fluorinated oils, organo-metallic fluids, phthalates (e.g., diisononyl phthalate), plasticizers, slip agents, volatile and non-volatile solvents, lubricants, reactive and/or non-reactive fluids, particulates, nano particles, pigments, dyes, surfactants, phase change materials, PDMS, dibutyl sebacate, dibutyl phthalate, hydrocarbon oils, dioctyl adipate, dioctyl sebacate, diethyl phthalate, di-butyl phthalate, di-n-hexyl phthalate, di-n-cetyl phthalate, di-n-decyl phthalate, di-n-dodecyl phthalate, perfluoropolyether oils from Solvay, Daikin and Dupont, plant oils, animal oils, hydrophilic liquids, hygroscopic liquids, polyethylene glycol, low molecular weight polypropylene glycol, liquid biomolecules (or solutions comprising liquid biomolecules), low molecular weight amino acids, polysaccharides, lignins, PTFE, hydrophilic materials, such as poly(ethylene glycol) (PEG), and low molecular weight poly(propylene glycol) (PPG).

Persons of skill in the art are familiar with phase change materials, and are familiar with a wide range of materials known as phase change materials. Any suitable phase change material (or phase change materials) can be employed in embodiments in accordance with the present inventive subject matter.

Phase change materials include any material with a relatively high heat of fusion (i.e., changes in state from liquid to solid and/or from solid to liquid). In some cases, however, phase change materials can be used based on their heat of vaporization (i.e., changes in state from gas to liquid and/or from liquid to gas), or heat of sublimation (i.e., changes in state from solid to gas and/or from gas to solid). Phase change material with relatively high heat of fusion melt and solidify at a certain temperature, and therefore are capable of storing and releasing large amounts of energy. Heat is absorbed when the material changes from solid to liquid (and heat is released when the material changes from liquid to solid). Phase change materials are usually used in such a way that they change between two physical states, but they can be used in such a way that they change among three physical states (gas to liquid to solid, solid to liquid to gas), or from one solid state to another solid state.

Within the range between 20 and 30 degrees C., some phase change materials can store 5 to 14 times more heat per unit volume than conventional storage materials such as water, masonry or rock.

Representative examples of phase change materials include organic phase change materials (e.g., bio-based or paraffin (CₙH₂ₙ₊₂), or carbohydrate and lipid-derived), inorganic phase change materials (e.g., salt hydrates such as MnH₂O), inorganic eutectics, hygroscopic materials, solid-solid phase change materials).

The following is a list of representative specific materials that can be used as phase change materials:
water, sodium sulfate (Na₂SO₄.10H₂O), NaCl.Na₂SO₄.10H₂O, lauric acid, TME/H₂O (e.g., TME (63%)/H₂O (37%)), Mn(NO₃)₂.6H₂O/MnCl₂.4H₂O (e.g., Mn(NO₃)₂.6H₂O/MnCl₂.4H₂O (4%)), Na₂SiO₃.5H₂O, aluminum, copper, gold, iron, lead, lithium, silver, titanium, zinc, NaNO₃, NaNO₂, NaOH, KNO₃, KOH, NaOH/Na₂CO₃ (e.g., NaOH/Na₂CO₃ (7.2%)), NaCl/NaOH (e.g., NaCl (26.8%)/NaOH), NaCl/KCl/LiCl (e.g., NaCl/KCl (32.4%)/LiCl (32.8%)), NaCl/NaNO₃/Na₂SO₄ (e.g., NaCl (5.7%)/NaNO₃ (85.5%)/Na₂SO₄), NaCl/NaNO₃ (e.g., NaCl/NaNO₃ (5.0%)), NaCl/NaNO₃ (e.g., NaCl (5.0%)/NaNO₃), NaCl/KCl/MgCl₂ (e.g., NaCl (42.5%)/KCl (20.5%)/MgCl₂), KNO₃/NaNO₃ (e.g., KNO₃ (10%)/NaNO₃), KNO₃/KCl (e.g., KNO₃/KCl (4.5%)), KNO₃/KBr/KCl (e.g., KNO₃/KBr (4.7%)/KCl (7.3%)), paraffin 14-carbons, paraffin 15-carbons, paraffin 16-carbons, paraffin 17-carbons, paraffin 18-carbons, paraffin 19-carbons, paraffin 20-carbons, paraffin 21-carbons, paraffin 22-carbons, paraffin 23-carbons, paraffin 24-carbons, paraffin 25-carbons, paraffin 26-carbons, paraffin 27-carbons, paraffin 28-carbons, paraffin 29-carbons, paraffin 30-carbons, paraffin 31-carbons, paraffin 32-carbons, paraffin 33-carbons, paraffin 34-carbons, formic acid, caprilic acid, glycerin, p-lactic acid, methyl palmitate, camphenilone, docasyl bromide, caprylone, phenol, heptadecanone, 1-cyclohexylooctadecane, 4-heptadacanone, p-joluidine, cyanamide, methyl eicosanate, 3-heptadecanone, 2-heptadecanone, hydrocinnamic acid, cetyl acid, a-nepthylamine, camphene, O-nitroaniline, 9-heptadecanone, thymol, methyl behenate, diphenyl amine, p-dichlorobenzene, oxolate, hypophosphoric acid, O-xylene dichloride, β-chloroacetic acid, chloroacetic acid, nitro napthalene, trimyristin, heptaudecanoic acid, a-chloroacetic acid, bees wax, glyolic acid, glycolic acid, p-bromophenol, azobenzene, acrylic acid, dinto toluent (2, 4), phenylacetic acid, thiosinamine, bromcamphor, durene, methyl bromobenzoate, alpha napthol, glautaric acid, p-xylene dichloride, catechol, quinone, actanilide, succinic anhydride, benzoic acid, stibene, benzamide, acetic acid, polyethylene glycol 600, capric acid, eladic acid, pentadecanoic acid, tristearin, myristic acid, palmatic acid, stearic acid, acetamide, and methyl fumarate.

In some embodiments according to the first aspect of the present inventive subject matter, which can include or not include, as suitable, any of the other features described herein, the first operating material further comprises at least one compound selected from among the group of compounds consisting of one or more free nano particles, one or more surfactants, one or more dyes, one or more pigments, one or more non-functional particles, one or more hydrophobic particles, one or more absorbent materials, one or more quasi-crystalline materials, one or more semi crystalline-containing materials, one or more biphasic materials, one or more triphasic materials, one or more higher-than-tri-phasic materials, one or more immiscible materials, one or more miscible materials, one or more surfactants, and/or one or more volatile liquids.

In some embodiments according to the first aspect of the present inventive subject matter, which can include or not include, as suitable, any of the other features described herein, the first operating material comprises at least 40 percent by weight of said composition (and in some embodiments, the first operating material comprises at least 20 percent by weight of said composition; in some embodiments, the first operating material comprises at least 30 percent by weight of said composition; and in some of such embodiments, the first operating material comprises at least 50 percent by weight of said composition).

In some embodiments according to the first aspect of the present inventive subject matter, which can include or not include, as suitable, any of the other features described herein, the first operating material comprises at least a first operating fluid and/or at least a first operating solid.

In some embodiments according to the first aspect of the present inventive subject matter, which can include or not include, as suitable, any of the other features described herein:
each of at least 50 percent of the plurality of nuclear moieties in the first lattice structure is bonded to three elongated moieties in the first lattice structure, and each of at least 50 percent of the plurality of elongated moieties in the first lattice structure is bonded to three nuclear moieties in the first lattice structure; or
each of at least 50 percent of the plurality of nuclear moieties in the first lattice structure is bonded to four elongated moieties in the first lattice structure, and each of at least 50 percent of the plurality of elongated moieties in the first lattice structure is bonded to three nuclear moieties in the first lattice structure; or
each of at least 50 percent of the plurality of nuclear moieties in the first lattice structure is bonded to five elongated moieties in the first lattice structure, and each of at least 50 percent of the plurality of elongated moieties in the first lattice structure is bonded to three nuclear moieties in the first lattice structure; or
each of at least 50 percent of the plurality of nuclear moieties in the first lattice structure is bonded to six elongated moieties in the first lattice structure, and each of at least 50 percent of the plurality of elongated moieties in the first lattice structure is bonded to three nuclear moieties in the first lattice structure; or
each of at least 50 percent of the plurality of nuclear moieties in the first lattice structure is bonded to three elongated moieties in the first lattice structure, and each of at least 50 percent of the plurality of elongated moieties in the first lattice structure is bonded to four nuclear moieties in the first lattice structure; or
each of at least 50 percent of the plurality of nuclear moieties in the first lattice structure is bonded to four elongated moieties in the first lattice structure, and each of at least 50 percent of the plurality of elongated moieties in the first lattice structure is bonded to four nuclear moieties in the first lattice structure; or
each of at least 50 percent of the plurality of nuclear moieties in the first lattice structure is bonded to five elongated moieties in the first lattice structure, and each of at least 50 percent of the plurality of elongated moieties in the first lattice structure is bonded to four nuclear moieties in the first lattice structure; or
each of at least 50 percent of the plurality of nuclear moieties in the first lattice structure is bonded to six elongated moieties in the first lattice structure, and each of at least 50 percent of the plurality of elongated moieties in the first lattice structure is bonded to four nuclear moieties in the first lattice structure; or
each of at least 50 percent of the plurality of nuclear moieties in the first lattice structure is bonded to three elongated moieties in the first lattice structure, and each of at least 50 percent of the plurality of elongated moieties in the first lattice structure is bonded to five nuclear moieties in the first lattice structure; or
each of at least 50 percent of the plurality of nuclear moieties in the first lattice structure is bonded to four elongated moieties in the first lattice structure, and each of at least 50 percent of the plurality of elongated moieties in the first lattice structure is bonded to five nuclear moieties in the first lattice structure; or
each of at least 50 percent of the plurality of nuclear moieties in the first lattice structure is bonded to five elongated moieties in the first lattice structure, and each of at least 50 percent of the plurality of elongated moieties in the first lattice structure is bonded to five nuclear moieties in the first lattice structure; or
each of at least 50 percent of the plurality of nuclear moieties in the first lattice structure is bonded to six elongated moieties in the first lattice structure, and each of at least 50 percent of the plurality of elongated moieties in the first lattice structure is bonded to five nuclear moieties in the first lattice structure; or
each of at least 50 percent of the plurality of nuclear moieties in the first lattice structure is bonded to three elongated moieties in the first lattice structure, and each of at least 50 percent of the plurality of elongated moieties in the first lattice structure is bonded to six nuclear moieties in the first lattice structure; or
each of at least 50 percent of the plurality of nuclear moieties in the first lattice structure is bonded to four elongated moieties in the first lattice structure, and each of at least 50 percent of the plurality of elongated moieties in the first lattice structure is bonded to six nuclear moieties in the first lattice structure; or
each of at least 50 percent of the plurality of nuclear moieties in the first lattice structure is bonded to five elongated moieties in the first lattice structure, and each of at least 50 percent of the plurality of elongated moieties in the first lattice structure is bonded to six nuclear moieties in the first lattice structure; or
each of at least 50 percent of the plurality of nuclear moieties in the first lattice structure is bonded to six elongated moieties in the first lattice structure, and each of at least 50 percent of the plurality of elongated moieties in the first lattice structure is bonded to six nuclear moieties in the first lattice structure; or
each of at least 50 percent of the plurality of nuclear moieties in the first lattice structure is bonded to more than six elongated moieties in the first lattice structure, and each of at least 50 percent of the plurality of elongated moieties in the first lattice structure is bonded to more than six nuclear moieties in the first lattice structure.

In some embodiments according to the first aspect of the present inventive subject matter, which can include or not include, as suitable, any of the other features described herein, the composition further comprises at least one reaction promoter (e.g., which may be used to promote reaction between [1] one or more compounds to which nuclear moieties correspond, and [2] one or more compounds to which elongated moieties correspond (in making a lattice structure), and which remain after such reaction. Examples of suitable compounds that can be used as reaction promoters include one or more compounds selected from among the group consisting of N-2-aminoethyl-3-aminopropyltriethoxysilane, gamma-aminopropyltriethoxysilane, gamma-aminopropyltrimethoxysilane, aminopropyltrimethoxysilane, bis-gamma-trimethoxysilylpropylamine, N-phenyl-gamma-aminopropyltrimethoxysilane, triaminofunctional trimethoxysilane, gamma-aminopropylmethyldiethoxysilane, gamma-aminopropylmethyldiethoxysilane, methacryloxypropyltrimethoxysilane, methylaminopropyltrimethoxysilane, gamma-glycidoxypropylethyldimethoxysilane, beta-glycidoxypropyltrimethoxysilane, beta-glycidoxyethyltrimethoxysilane, beta-(3,4-epoxycyclohexyl)propyltrimethoxysilane, beta-(3,4-epoxycyclohexyl)ethylmethyldimethoxysilane, isocyanatopropyltriethoxysilane, isocyanatopropylmethyldimethoxysilane, beta-cyanoethyltrimethoxysilane, gamma-acryloxypropyltrimethoxysilane, gamma-methacryloxypropylmethyldimethoxysilane, 4-amino-3,3-dimethylbutyltrimethoxysilane, and N-ethyl-3-trimethoxysilyl-2-methylpropaneamine.

In accordance with a second aspect of the present inventive subject matter, there is provided a composition, comprising:

a plurality of nuclear moiety precursor compounds;

a plurality of elongated moiety precursor compounds; and

at least a first operating material,

the plurality of nuclear moiety precursor compounds comprising at least a first nuclear moiety precursor compound,

the plurality of elongated moiety precursor compounds comprising at least a first elongated moiety precursor compound,

the first nuclear moiety precursor compound selected from among the group of compounds consisting of 2-Butanone, O,O′,O″-silanetetrayltetraoxime, 2-Butanone,O,O′,O″-(Methylsilylidyne)Trioxime, Tetramethoxysilane, Tetraethoxysilane, Tetraethyl orthosilicates, Tetrachlorosilane, Trichlorosilane, Tungsten hexachloride, Molybdenum hexacarbonyl, 1,2 Bis(Triethoxysilyl)ethane, and 1,2 Bis(Triethoxysilyl)methane, Molybdenum (VI) oxide bis(pentanedionate, Molybdenum (VI) oxide bis(2,2,6,6-tetramethyl-3,5-heptanedionate, and Tungsten (VI) phenoxide, methyltrimethoxysilane, chloromethyltrimethoxysilane, ethyltrimethoxysilane, propyltrimethoxysilane, vinyltrimethoxysilane, methyltriethoxysilane, vinyltriethoxysilane, phenyltriethoxysilane, methyltripropoxysilane, phenyltripropoxysilane, tetramethoxysilane, tetraethoxysilane, tetra-n-propoxysilane, tetra-n-butoxysilane, methyltris(methylethylketoxime)silane, phenyltris(methylethylketoxime)silane, vinyltris(methylethylketoxime)silane, methyltris(methylisobutylketoxime)silane, methyltris(methylpropylketoxime)silane, and tetra(rnethylethylketoxime)silane,

the first elongated moiety precursor compound selected from among the group of compounds consisting of silane-terminated polyethers (fluorinated in one or more location or not fluorinated), oxime-terminated polyethers (fluorinated in one or more location or not fluorinated), silane-terminated urethanes (fluorinated in one or more location or not fluorinated), oxime-terminated urethanes (fluorinated in one or more location or not fluorinated), silane-terminated alkyl polymers, silane-terminated aryl polymers, oxime-terminated alkyl polymers, oxime-terminated aryl polymers, hydrophilic materials, such as poly(ethylene glycol) (PEG), and low molecular weight poly(propylene glycol) (PPG), the first operating material comprising at least one compound selected from among the group of compounds consisting of volatile and/or non-volatile oils, organic oils, silicone oils, fluorinated oils, organo-metallic fluids, phthalates (e.g., diisononyl phthalate), plasticizers, slip agents, volatile and non-volatile solvents, lubricants, reactive and/or non-reactive fluids, particulates, nano particles, pigments, dyes, surfactants, PDMS, dibutyl sebacate, dibutyl phthalate, hydrocarbon oils, dioctyl adipate, dioctyl sebacate, diethyl phthalate, di-butyl phthalate, di-n-hexyl phthalate, di-n-cctyl phthalate, di-n-decyl phthalate, di-n-dodecyl phthalate, perfluoropolyether oils from Solvay, Daikin and Dupont, plant oils, animal oils, hydrophilic liquids, hygroscopic liquids, polyethylene glycol, low molecular weight polypropylene glycol, liquid biomolecules (or solutions comprising liquid biomolecules), low molecular weight amino acids, polysaccharides, lignins, PTFE, hydrophilic materials, such as poly(ethylene glycol) (PEG), low molecular weight poly(propylene glycol) (PPG), water, sodium sulfate (Na₂SO₄.10H₂O), NaCl.Na₂SO₄.10H₂O, lauric acid, TME/H₂O (e.g., TME (63%)/H₂O (37%)), Mn(NO₃)₂.6H₂O/MnCl₂.4H₂O (e.g., Mn(NO₃)₂.6H₂O/MnCl₂.4H₂O (4%)), Na₂SiO₃.5H₂O, aluminum, copper, gold, iron, lead, lithium, silver, titanium, zinc, NaNO₃, NaNO₂, NaOH, KNO₃, KOH, NaOH/Na₂CO₃ (e.g., NaOH/Na₂CO₃ (7.2%)), NaCl/NaOH (e.g., NaCl (26.8%)/NaOH), NaCl/KCl/LiCl (e.g., NaCl/KCl (32.4%)/LiCl (32.8%)), NaCl/NaNO₃/Na₂SO₄ (e.g., NaCl (5.7%)/NaNO₃ (85.5%)/Na₂SO₄), NaCl/NaNO₃ (e.g., NaCl/NaNO₃ (5.0%)), NaCl/NaNO₃ (e.g., NaCl (5.0%)/NaNO₃), NaCl/KCl/MgCl₂ (e.g., NaCl (42.5%)/KCl (20.5%)/MgCl₂), KNO₃/NaNO₃ (e.g., KNO₃ (10%)/NaNO₃), KNO₃/KCl (e.g., KNO₃/KCl (4.5%)), KNO₃/KBr/KCl (e.g., KNO₃/KBr (4.7%)/KCl (7.3%)), paraffin 14-carbons, paraffin 15-carbons, paraffin 16-carbons, paraffin 17-carbons, paraffin 18-carbons, paraffin 19-carbons, paraffin 20-carbons, paraffin 21-carbons, paraffin 22-carbons, paraffin 23-carbons, paraffin 24-carbons, paraffin 25-carbons, paraffin 26-carbons, paraffin 27-carbons, paraffin 28-carbons, paraffin 29-carbons, paraffin 30-carbons, paraffin 31-carbons, paraffin 32-carbons, paraffin 33-carbons, paraffin 34-carbons, formic acid, caprilic acid, glycerin, p-lactic acid, methyl palmitate, camphenilone, docasyl bromide, caprylone, phenol, heptadecanone, 1-cyclohexylooctadecane, 4-heptadacanone, p-joluidine, cyanamide, methyl eicosanate, 3-heptadecanone, 2-heptadecanone, hydrocinnamic acid, cetyl acid, a-nepthylamine, camphene, O-nitroaniline, 9-heptadecanone, thymol, methyl behenate, diphenyl amine, p-dichlorobenzene, oxolate, hypophosphoric acid, O-xylene dichloride, β-chloroacetic acid, chloroacetic acid, nitro napthalene, trimyristin, heptaudecanoic acid, a-chloroacetic acid, bees wax, glyolic acid, glycolic acid, p-bromophenol, azobenzene, acrylic acid, dinto toluent (2, 4), phenylacetic acid, thiosinamine, bromcamphor, durene, methyl bromohenzoate, alpha napthol, glautaric acid, p-xylene dichloride, catechol, quinone, actanilide, succinic anhydride, benzoic acid, stibene, benzamide, acetic acid, polyethylene glycol 600, capric acid, eladic acid, pentadecanoic acid, tristearin, myristic acid, palmatic acid, stearic acid, acetamide, and methyl fumarate, and/or the first operating material further comprises at least one compound selected from among the group of compounds consisting of one or more free nano particles, one or more surfactants, one or more dyes, one or more pigments, one or more non-functional particles, one or more hydrophobic particles, one or more absorbent materials, one or more quasi-crystalline materials, one or more semi crystalline-containing materials, one or more biphasic materials, one or more triphasic materials, one or more higher-than-tri-phasic materials, one or more immiscible materials, one or more miscible materials, one or more surfactants, one or more volatile liquids.

In some embodiments according to the second aspect of the present inventive subject matter, which can include or not include, as suitable, any of the other features described herein, a sum of [1] nuclear moiety precursor compounds (selected from among the group consisting of 2-Butanone, O,O′,O″-silanetetrayltetraoxime, 2-Butanone,O,O′,O″-(Methylsilylidyne)Trioxime, Tetramethoxysilane, Tetracthoxysilane, Tetraethyl orthosilicates, Tetrachlorosilane, Trichlorosilane, Tungsten hexachloride, Molybdenum hexacarbonyl, 1,2 Bis(Triethoxysilyl)ethane, and 1,2 Bis(Triethoxysilyl)methane, Molybdenum (VI) oxide bis(pentanedionate, Molybdenum (VI) oxide bis(2,2,6,6-tetramethyl-3,5-heptanedionate, Tungsten (VI) phenoxide), methyltrimethoxysilane, chloromethyltrimethoxysilane, ethyltrimethoxysilane, propyltrimethoxysilane, vinyltrimethoxysilane, methyltriethoxysilane, vinyltriethoxysilane, phenyltriethoxysilane, methyltripropoxysilane, phenyltripropoxysilane, tetramethoxysilane, tetraethoxysilane, tetra-n-propoxysilane, tetra-n-butoxysilane, methyltris(methylethylketoxime)silane, phenyltris(methylethylketoxime)silane, vinyltris(methylethylketoxime)silane, methyltris(methylisobutylketoxime)silane, methyltris(methylpropylketoxime)silane, and tetra(methylethylketoxime)silane), and [2] elongated moiety precursor compounds (selected from among the group consisting of silane-terminated polyethers (fluorinated in one or more location or not fluorinated), oxime-terminated polyethers (fluorinated in one or more location or not fluorinated), silane-terminated urethanes (fluorinated in one or more location or not fluorinated), oxime-terminated urethanes (fluorinated in one or more location or not fluorinated), silane-terminated alkyl polymers, silane-terminated aryl polymers, oxime-terminated alkyl polymers, oxime-terminated aryl polymers, hydrophilic materials, such as poly(ethylene glycol) (PEG), and low molecular weight poly(propylene glycol) (PPG)), accounts for at least 40 percent by weight of the composition.

In some embodiments according to the second aspect of the present inventive subject matter, which can include or not include, as suitable, any of the other features described herein, the first operating material accounts for at least 40 percent by weight of said composition (and in some of such embodiments, the first operating material accounts for at least 20 percent by weight of said composition; in some embodiments, the first operating material accounts for at least 30 percent by weight of said composition; and in some embodiments, the first operating material accounts for at least 50 percent by weight of said composition).

In some embodiments according to the second aspect of the present inventive subject matter, which can include or not include, as suitable, any of the other features described herein, the composition comprises at least a first solvent.

In some embodiments according to the second aspect of the present inventive subject matter, which can include or not include, as suitable, any of the other features described herein, the composition further comprises at least one reaction promoter. Examples of suitable compounds that can be used as reaction promoters include one or more compounds selected from among the group consisting of N-2-aminoethyl-3-aminopropyltriethoxysilane, gamma-aminopropyltriethoxysilane, gamma-aminopropyltrimethoxysilane, aminopropyltrimethoxysilane, bis-gamma-trimethoxysilylpropylamine, N-phenyl-gamma-aminopropyltrimethoxysilane, triaminofunctional trimethoxysilane, gamma-aminopropylmethyldiethoxysilane, gamma-aminopropylmethyldiethoxysilane, methacryloxypropyltrimethoxysilane, methylaminopropyltrimethoxysilane, gamma-glycidoxypropylethyldimethoxysilane, beta-glycidoxypropyltrimethoxysilane, beta-glycidoxyethyltrimethoxysilane, beta-(3,4-epoxycyclohexyl)propyltrimethoxysilane, beta-(3,4-epoxycyclohexyl)ethylmethyldimethoxysilane, isocyanatopropyltriethoxysilane, isocyanatopropylmethyldimethoxysilane, beta-cyanoethyltrimethoxysilane, gamma-acryloxypropyltrimethoxysilane, gamma-methacryloxypropylmethyldimethoxysilane, 4-amino-3,3-dimethylbutyltrimethoxysilane, and N-ethyl-3-trimethoxysilyl-2-methylpropaneamine.

In accordance with a third aspect of the present inventive subject matter, there is provided a method, comprising:
supplying at least [1] nuclear moiety precursor compounds, [2] elongated moiety precursor compounds, and [3] operating material compounds to a space; and
removing from the space a composition comprising at least a first lattice structure and a plurality of said operating material compounds, the first lattice structure comprising a plurality of nuclear moieties and a plurality of elongated moieties,
each of the plurality of nuclear moieties corresponding to (as defined herein) a respective one of the nuclear moiety precursor compounds,
each of the plurality of elongated moieties corresponding to (as defined herein) a respective one of the elongated moiety precursor compounds,
each of at least some of the plurality of nuclear moieties chemically bonded to at least three of the plurality of elongated moieties,
each of at least some of the plurality of elongated moieties chemically bonded to at least two of the plurality of nuclear moieties,
the first lattice structure defining a plurality of respective cells.

In some embodiments according to the third aspect of the present inventive subject matter, which can include or not include, as suitable, any of the other features described herein, at least some of said nuclear moiety precursor compounds are selected from among the group of compounds consisting of 2-Butanone, O,O′,O″-silanetetrayltetraoxime, 2-Butanone,O,O′,O″-(Methylsilylidyne)Trioxime, Tetramethoxysilane, Tetraethoxysilane, Tetraethyl orthosilicates, Tetrachlorosilane, Trichlorosilane. Tungsten hexachloride, Molybdenum hexacarbonyl, 1,2 Bis(Triethoxysilyl)ethane, and 1,2 Bis(Triethoxysilyl)methane, Molybdenum (VI) oxide bis(pentanedionate, Molybdenum (VI) oxide bis(2,2,6,6-tetramethyl-3,5-heptanedionate, Tungsten (VI) phenoxide, methyltrimethoxysilane, chloromethyltrimethoxysilane, ethyltrimethoxysilane, propyltrimethoxysilane, vinyltrimethoxysilane, methyltriethoxysilane, vinyltriethoxysilane, phenyltriethoxysilane methyltripropoxysilane, phenyltripropoxysilane, tetramethoxysilane, tetraethoxysilane, tetra-n-propoxysilane, tetra-n-butoxysilane, methyltris(methylethylketoxime)silane, phenyltris(methylethylketoxime)silane, vinyltris(methylethylketoxime)silane, methyltris(methylisobutylketoxime)silane, methyltris(methylpropylketoxime)silane, and tetra(methylethylketoxime)silane, and/or at least some of said elongated moiety precursor compounds are selected from among the group of compounds consisting of silane-terminated polyethers (fluorinated in one or more location or not fluorinated), oxime-terminated polyethers (fluorinated in one or more location or not fluorinated), silane-terminated urethanes (fluorinated in one or more location or not fluorinated), oxime-terminated urethanes (fluorinated in one or more location or not fluorinated), silane-terminated alkyl polymers, silane-terminated aryl polymers, oxime-terminated alkyl polymers, oxime-terminated aryl polymers, hydrophilic materials, such as poly(ethylene glycol) (PEG), and low molecular weight poly(propylene glycol) (PPG).

In some embodiments according to the third aspect of the present inventive subject matter, which can include or not include, as suitable, any of the other features described herein, moieties selected from among moieties that correspond to compounds selected from among the group consisting of 2-Butanone, O,O′,O″-silanetetrayltetraoxime, 2-Butanone,O,O′,O″-(Methylsilylidyne)Trioxime, Tetramethoxysilane, Tetraethoxysilane, Tetraethyl orthosilicates, Tetrachlorosilane, Trichlorosilane, Tungsten hexachloride, Molybdenum hexacarbonyl, 1,2 Bis(Triethoxysilyl)ethane, and 1,2 Bis(Triethoxysilyl)methane, Molybdenum (VI) oxide bis(pentanedionate, Molybdenum (VI) oxide bis(2,2,6,6-tetramethyl-3,5-heptanedionate, Tungsten (VI) phenoxide, methyltrimethoxysilane, chloromethyltrimethoxysilane, ethyltrimethoxysilane, propyltrimethoxysilane, vinyltrimethoxysilane, methyltriethoxysilane, vinyltriethoxysilane, phenyltriethoxysilane, methyltripropoxysilane, phenyltripropoxysilane, tetramethoxysilane, tetraethoxysilane, tetra-n-propoxysilane, tetra-n-butoxysilane, methyltris(methylethylketoxime)silane, phenyltris(methylethylketoxime)silane, vinyltris(methylethylketoxime)silane, methyltris(methylisobutylketoxime)silane, methyltris(methylpropylketoxime)silane, tetra(methylethylketoxime)silane, silane-terminated polyethers (fluorinated in one or more location or not fluorinated), oxime-terminated polyethers (fluorinated in one or more location or not fluorinated), silane-terminated urethanes (fluorinated in one or more location or not fluorinated), oxime-terminated urethanes (fluorinated in one or more location or not fluorinated), silane-terminated alkyl polymers, silane-terminated aryl polymers, oxime-terminated alkyl polymers, oxime-terminated aryl polymers, hydrophilic materials, such as poly(ethylene glycol) (PEG), and low molecular weight poly(propylene glycol) (PPG), account for at least 80 atomic percent of the first lattice structure.

In some embodiments according to the third aspect of the present inventive subject matter, which can include or not include, as suitable, any of the other features described herein, each of at least some of said nuclear moiety precursor compounds comprises at least one nuclear moiety precursor compound functional moiety selected from among the group of moieties consisting of silanes, silols, oximes, dendrites, polysilsesquioxanes, halogens, compounds with one or more hydrolysable groups, siloxanes, silicones, compounds with one or more acrylic groups, compounds with one or more methacrylic groups, compounds with one or more vinyl groups, isocyanates, amines, amides, active hydrogens, compounds with one or more hydroxyl groups, compounds with one or more sulfur groups, epoxies, organo-metallics, organo-silicones, sulfides, halides, phosphates, organic alcohols, inorganic alcohols, organic acids and inorganic acids, and/or each of at least some of said elongated moiety precursor compounds comprises at least one elongated moiety precursor compound functional moiety selected from among the group of moieties consisting of silanes, silols, oximes, dendrites, polysilsesquioxanes, halogens, compounds with one or more hydrolysable groups, siloxanes, silicones, compounds with one or more acrylic groups, compounds with one or more methacrylic groups, compounds with one or more vinyl groups, isocyanates, amines, amides, active hydrogens, compounds with one or more hydroxyl groups, compounds with one or more sulfur groups, epoxies, organo-metallics, organo-silicones, sulfides, halides, phosphates, organic alcohols, inorganic alcohols, organic acids and inorganic acids.

In some embodiments according to the third aspect of the present inventive subject matter, which can include or not include, as suitable, any of the other features described herein, in said composition comprising at least a first lattice structure and a plurality of said operating material compounds, at least some of the first operating material compounds are in respective cells in the first lattice structure.

In sonic embodiments according to the third aspect of the present inventive subject matter, which can include or not include, as suitable, any of the other features described herein, the operating material compounds comprise at least one compound selected from among the group of compounds consisting of volatile and/or non-volatile oils, organic oils, silicone oils, fluorinated oils, organo-metallic fluids, phthalates (e.g., diisononyl phthalate), plasticizers, slip agents, volatile and non-volatile solvents, lubricants, reactive and/or non-reactive fluids, particulates, nano particles, pigments, dyes, surfactants, PDMS, dibutyl sebacate, dibutyl phthalate, hydrocarbon oils, dioctyl adipate, dioctyl sebacate, diethyl phthalate, di-butyl phthalate, di-n-hexyl phthalate, di-n-cetyl phthalate, di-n-decyl phthalate, di-n-dodecyl phthalate, perfluoropolyether oils from Solvay, Daikin and Dupont, plant oils, animal oils, hydrophilic liquids, hygroscopic liquids, polyethylene glycol, low molecular weight polypropylene glycol, liquid biomolecules (or solutions comprising liquid biomolecules), low molecular weight amino acids, polysaccharides, lignins, PTFE, hydrophilic materials, such as poly(ethylene glycol) (PEG), low molecular weight poly(propylene glycol) (PPG), water, sodium sulfate (Na₂SO₄.10H₂O), NaCl.Na₂SO₄.10H₂O, lauric acid, TME/H₂O (e.g., TME (63%)/H₂O (37%)), Mn(NO₃)₂.6H₂O/MnCl₂.4H₂O (e.g., Mn(NO₃)₂.6H₂O/MnCl₂.4H₂(4%)), Na₂SiO₃.5H₂O, aluminum, copper, gold, iron, lead, lithium, silver, titanium, zinc, NaNO₃, NaNO₂, NaOH, KNO₃, KOH, NaOH/Na₂CO₃ (e.g., NaOH/Na₂CO₃ (7.2%)), NaCl/NaOH (e.g., NaCl (26.8%)/NaOH), NaCl/KCl/LiCl (e.g., NaCl/KCl (32.4%)/LiCl (32.8%)), NaCl/NaNO₃/Na₂SO₄ (e.g., NaCl (5.7%)/NaNO₃ (85.5%)/Na₂SO₄), NaCl/NaNO₃ (e.g., NaCl/NaNO₃ (5.0%)), NaCl/NaNO₃ (e.g., NaCl (5.0%)/NaNO₃), NaCl/KCl/MgCl₂ (e.g., NaCl (42.5%)/KCl (20.5%)/MgCl₂), KNO₃/NaNO₃ (e.g., KNO₃ (10%)/NaNO₃), KNO₃/KCl (e.g., KNO₃/KCl (4.5%)), KNO₃/KBr/KCl (e.g., KNO₃/KBr (4.7%)/KCl (7.3%)), paraffin 14-carbons, paraffin 15-carbons, paraffin 16-carbons, paraffin 17-carbons, paraffin 18-carbons, paraffin 19-carbons, paraffin 20-carbons, paraffin 21-carbons, paraffin 22-carbons, paraffin 23-carbons, paraffin 24-carbons, paraffin 25-carbons, paraffin 26-carbons, paraffin 27-carbons, paraffin 28-carbons, paraffin 29-carbons, paraffin 30-carbons, paraffin 31-carbons, paraffin 32-carbons, paraffin 33-carbons, paraffin 34-carbons, formic acid, caprilic acid, glycerin, p-lactic acid, methyl palmitate, camphenilone, docasyl bromide, caprylone, phenol, heptadecanone, 1cyclohexylooctadecane, 4-heptadacanone, p-joluidine, cyanamide, methyl eicosanate, 3-heptadecanone, 2-heptadecanone, hydrocinnamic acid, cetyl acid, a-nepthylamine, camphene, O-nitroaniline, 9-heptadecanone, thymol, methyl behenate, diphenyl amine, p-dichlorobenzene, oxolate, hypophosphoric acid, O-xylene dichloride, β-chloroacetic acid, chloroacetic acid, nitro napthalene, trimyristin, heptaudecanoic acid, a-chloroacetic acid, bees wax, glyolic acid, glycolic acid, p-bromophenol, azobenzene, acrylic acid, dinto toluent (2, 4), phenylacetic acid, thiosinamine, bromcamphor, durene, methyl bromobenzoate, alpha napthol, glautaric acid, p-xylene dichloride, catechol, quinone, actanilide, succinic anhydride, benzoic acid, stibene, benzamide, acetic acid, polyethylene glycol 600, capric acid, eladic acid, pentadecanoic acid, tristearin, myristic acid, palmatic acid, stearic acid, acetamide, and methyl fumarate. In some of such embodiments, the operating material compounds further comprise at least one compound selected from among the group of compounds consisting of one or more free nano particles, one or more surfactants, one or more dyes, one or more pigments, one or more non-functional particles, one or more hydrophobic particles, one or more absorbent materials, one or more quasi-crystalline materials, one or more semi crystalline-containing materials, one or more biphasic materials, one or more triphasic materials, one or more higher-than-tri-phasic materials, one or more immiscible materials, one or more miscible materials, one or more surfactants, and/or one or more volatile liquids.

In some embodiments according to the third aspect of the present inventive subject matter, which can include or not include, as suitable, any of the other features described. herein, the first operating material comprises at least 40 percent by weight of said composition (and in some of such embodiments, the first operating material comprises at least 20 percent by weight of said composition; in some embodiments, the first operating material comprises at least 30 percent by weight of said composition; and in some embodiments, the first operating material comprises at least 50 percent by weight of said composition).

In some embodiments according to the third aspect of the present inventive subject matter, which can include or not include, as suitable, any of the other features described herein, the first operating material comprises at least a first operating fluid and/or at least a first operating solid.

In some embodiments according to the third aspect of the present inventive subject matter, which can include or not include, as suitable, any of the other features described herein, the method comprises supplying at least a first solvent to the space.

In some embodiments according to the third aspect of the present inventive subject matter, which can include or not include, as suitable, any of the other features described herein, the method comprises supplying at least a first reaction promoter to the space (any such reaction promoter(s) can be supplied to the space before, during or after any of the [1] nuclear moiety precursor compounds, [2] elongated moiety precursor compounds, and [3] operating material compounds are supplied to the space. Examples of suitable compounds that can be used as reaction promoters include one or more compounds selected from among the group consisting of N-2-aminoethyl-3-aminopropyltriethoxysilane, gamma-aminopropyltriethoxysilane, gamma-aminopropyltrimethoxysilane, aminopropyltrimethoxysilane, bis-gamma-trimethoxysilylpropylamine, N-phenyl-gamma-aminopropyltrimethoxysilane, triaminofunctional trimethoxysilane, gamma-aminopropylmethyldiethoxysilane, gamma-aminopropylmethyldiethoxysilane, methacryloxypropyltrimethoxysilane, methylaminopropyltrimethoxysilane, gamma-glycidoxypropylethyldimethoxysilane, beta-glycidoxypropyltrimethoxysilane, beta-glycidoxyethyltrimethoxysilane, beta-(3,4-epoxycyclohexyl)propyltrimethoxysilane, beta-(3,4-epoxycyclohexyl)ethylmethyldimethoxysilane, isocyanatopropyltriethoxysilane, isocyanatopropylmethyldimethoxysilane, beta-cyanoethyltrimethoxysilane, gamma-acryloxypropyltrimethoxysilane, gamma-methacryloxypropylmethyldimethoxysilane, 4-amino-3,3-dimethylbutyltrimethoxysilane, and N-ethyl-3-trimethoxysilyl-2-methylpropaneamine.

In accordance with a fourth aspect of the present inventive subject matter, there is provided a composition, comprising:

a plurality of nuclear moiety precursor compounds; and

a plurality of elongated moiety precursor compounds,

the plurality of nuclear moiety precursor compounds comprising at least a first nuclear moiety precursor compound,

the plurality of elongated moiety precursor compounds comprising at least a first elongated moiety precursor compound,

the first nuclear moiety precursor compound selected from among the group of compounds consisting of 2-Butanone, O,O′,O″-silanetetrayltetraoxime, 2-Butanone,O,O′,O″-(Methylsilylidyne)Trioxime, Tetramethoxysilane, Tetraethoxysilane, Tetraethyl orthosilicates, Tetrachlorosilane, Trichlorosilane, Tungsten hexachloride, Molybdenum hexacarbonyl, 1,2 Bis(Triethoxysilyl)ethane, and 1,2 Bis(Triethoxysilyl)methane, Molybdenum (VI) oxide bis(pentanedionate, Molybdenum (VI) oxide bis(2,2,6,6-tetramethyl-3,5-heptanedionate, Tungsten (VI) phenoxide, methyltrimethoxysilane, chloromethyltrimethoxysilane, ethyltrimethoxysilane, propyltrimethoxysilane, vinyltrimethoxysilane, methyltriethoxysilane, vinyltriethoxysilane, phenyltriethoxysilane, methyltripropoxysilane, phenyltripropoxysilane, tetramethoxysilane, tetraethoxysilane, tetra-n-propoxysilane, tetra-n-butoxysilane, methyltris(methylethylketoxime)silane, phenyltris(methylethylketoxime)silane, vinyltris(methylethylketoxime)silane, methyltris(methylisobutylketoxime)silane, methyltris(methylpropylketoxime)silane, and tetra(methylethylketoxime)silane,

the first elongated moiety precursor compound selected from among the group of compounds consisting of silane-terminated polyethers (fluorinated in one or more location or not fluorinated), oxime-terminated polyethers (fluorinated in one or more location or not fluorinated), silane-terminated urethanes (fluorinated in one or more location or not fluorinated), oxime-terminated urethanes (fluorinated in one or more location or not fluorinated), silane-terminated alkyl polymers, silane-terminated aryl polymers, oxime-terminated alkyl polymers, oxime-terminated aryl polymers, hydrophilic materials, such as poly(ethylene glycol) (PEG), and low molecular weight poly(propylene glycol) (PPG).

In some embodiments according to the fourth aspect of the present inventive subject matter, which can include or not include, as suitable, any of the other features described herein, a sum of [1] nuclear moiety precursor compounds (selected from among the group consisting of 2-Butanone, O,O′,O″-silanetetrayltetraoxime, 2-Butanone,O,O′,O″-(Methylsilylidyne)Trioxime, Tetramethoxysilane, Tetraethoxysilane, Tetraethyl orthosilicates, Tetrachlorosilane, Trichlorosilane, Tungsten hexachloride, Molybdenum hexacarbonyl, 1,2 Bis(Triethoxysilyl)ethane, and 1,2 Bis(Triethoxysilyl)methane, Molybdenum (VI) oxide bis(pentanedionate, Molybdenum (VI) oxide bis(2,2,6,6-tetramethyl-3,5-heptanedionate, Tungsten (VI) phenoxide), methyltrimethoxysilane, chloromethyltrimethoxysilane, ethyltrimethoxysilane, propyltrimethoxysilane, vinyltrimethoxysilane, methyltriethoxysilane, vinyltriethoxysilane, phenyltriethoxysilane, methyltripropoxysilane, phenyltripropoxysilane, tetramethoxysilane, tetraethoxysilane, tetra-n-propoxysilane, tetra-n-butoxysilane, methyltris(methylethylketoxime)silane, phenyltris(methylethylketoxime)silane, vinyltris(methylethylketoxime)silane, methyltris(methylisobutylketoxime)silane, methyltris(methylpropylketoxime)silane, and tetra(methylethylketoxime)silane), and [2] elongated moiety precursor compounds (selected from among the group consisting of silane-terminated polyethers (fluorinated in one or more location or not fluorinated), oxime-terminated polyethers (fluorinated in one or more location or not fluorinated), silane-terminated urethanes (fluorinated in one or more location or not fluorinated), oxime-terminated urethanes (fluorinated in one or more location or not fluorinated), silane-terminated alkyl polymers, silane-terminated aryl polymers, oxime-terminated alkyl polymers, oxime-terminated aryl polymers, hydrophilic materials, such as poly(ethylene glycol) (PEG), and low molecular weight poly(propylene glycol) (PPG)), accounts for at least 40 percent by weight of the composition.

In some embodiments according to the fourth aspect of the present inventive subject matter, which can include or not include, as suitable, any of the other features described herein, the composition further comprises at least a first operating material. In some of such embodiments, the first operating material comprises at least one compound selected from among the group of compounds consisting of volatile and/or non-volatile oils, organic oils, silicone oils, fluorinated oils, organo-metallic fluids, phthalates (e.g., diisononyl phthalate), plasticizers, slip agents, volatile and non-volatile solvents, lubricants, reactive and/or non-reactive fluids, particulates, nano particles, pigments, dyes, surfactants, PDMS, dibutyl sebacate, dibutyl phthalate, hydrocarbon oils, dioctyl adipate, dioctyl sebacate, diethyl phthalate, di-butyl phthalate, di-n-hexyl phthalate, di-n-cetyl phthalate, di-n-decyl phthalate, di-n-dodecyl phthalate, perfluoropolyether oils from Solvay, Daikin and Dupont, plant oils, animal oils. hydrophilic liquids, hygroscopic liquids, polyethylene glycol, low molecular weight polypropylene glycol, liquid biomolecules (or solutions comprising liquid biomolecules), low molecular weight amino acids, polysaccharides, lignins, PTFE, hydrophilic materials, such as poly(ethylene glycol) (PEG), low molecular weight poly(propylene glycol) (PPG), water, sodium sulfate (Na₂SO₄.10H₂O), NaCl.Na₂SO₄.10H₂O, lauric acid, TME/H₂O (e.g., TME (63%)/H₂O (37%)), Mn(NO₃)₂.6H₂O/MnCl₂.4H₂O (e.g., Mn(NO₃)₂.6H₂O/MnCl₂.4H₂O (4%)), Na₂SiO₃.5H₂O, aluminum, copper, gold, iron, lead, lithium, silver, titanium, zinc, NaNO₃, NaNO₂, NaOH, KNO₃, KOH, NaOH/Na₂CO₃ (e.g., NaOH/Na₂CO₃ (7.2%)), NaCl/NaOH (e.g., NaCl (26.8%)/NaOH), NaCl/KCl/LiCl (e.g., NaCl/KCl (32.4%)/LiCl (32.8%)), NaCl/NaNO₃/Na₂SO₄ (e.g., NaCl (5.7%)/NaNO₃ (85.5%)/Na₂SO₄), NaCl/NaNO₃ (e.g., NaCl/NaNO₃ (5.0%)), NaCl/NaNO₃ (e.g., NaCl (5.0%)/NaNO₃), NaCl/KCl/MgCl₂ (e.g., NaCl (42.5%)/KCl (20.5%)/MgCl₂), KNO₃/NaNO₃ (e.g., KNO₃ (10%)/NaNO₃), KNO₃/KCl (e.g., KNO₃/KCl (4.5%)), KNO₃/KBr/KCl (e.g., KNO₃/KBr (4.7%)/KCl (7.3%)), paraffin 14-carbons, paraffin 15-carbons, paraffin 16-carbons, paraffin 17-carbons, paraffin 18-carbons, paraffin 19-carbons, paraffin 20-carbons, paraffin 21-carbons, paraffin 22-carbons, paraffin 23-carbons, paraffin 24-carbons, paraffin 25-carbons, paraffin 26-carbons, paraffin 27-carbons, paraffin 28-carbons, paraffin 29-carbons, paraffin 30-carbons, paraffin 31-carbons, paraffin 32-carbons, paraffin 33-carbons, paraffin 34-carbons, formic acid, caprilic acid, glycerin, p-lactic acid, methyl palmitate, camphenilone, docasyl bromide, caprylone, phenol, heptadecanone, 1cyclohexylooctadecane, 4-heptadacanone, p-joluidine, cyanamide, methyl eicosanate. 3-heptadecanone, 2-heptadecanone, hydrocinnamic acid, cetyl acid, a-nepthylamine, camphene, O-nitroaniline, 9-heptadecanone, thymol, methyl behenate, diphenyl amine, p-dichlorobenzene, oxolate, hypophosphoric acid, O-xylene dichloride, β-chloroacetic acid, chloroacetic acid, nitro napthalene, trimyristin, heptaudecanoic acid, a-chloroacetic acid, bees wax, glyolic acid, glycolic acid, p-bromophenol, azobenzene, acrylic acid, dinto toluent (2, 4), phenylacetic acid, thiosinamine, bromcamphor, durene, methyl bromobenzoate, alpha napthol, glautaric acid, p-xylene dichloride, catechol, quinone, actanilide, succinic anhydride, benzoic acid, stibene, benzamide, acetic acid, polyethylene glycol 600, capric acid, eladic acid, pentadecanoic acid, tristearin, myristic acid, palmatic acid, stearic acid, acetamide, and methyl fumarate, and/or the first operating material further comprises at least one compound selected from among the group of compounds consisting of one or more free nano particles, one or more surfactants, one or more dyes, one or more pigments, one or more non-functional particles, one or more hydrophobic particles, one or more absorbent materials, one or more quasi-crystalline materials, one or more semi crystalline-containing materials, one or more biphasic materials, one or more triphasic materials, one or more higher-than-tri-phasic materials, one or more immiscible materials, one or more miscible materials, one or more surfactants, one or more volatile liquids, and/or the composition comprises at least a first solvent.

In some embodiments according to the fourth aspect of the present inventive subject matter, which can include or not include, as suitable, any of the other features described herein, the first operating material accounts for at least 40 percent by weight of said composition (and in some of such embodiments, the first operating material accounts for at least 20 percent by weight of said composition; in some embodiments, the first operating material accounts for at least 30 percent by weight of said composition; and in some embodiments, the first operating material accounts for at least 50 percent by weight of said composition).

In some embodiments according to the fourth aspect of the present inventive subject matter, which can include or not include, as suitable, any of the other features described herein, the composition comprises at least a first solvent.

In some embodiments according to the fourth aspect of the present inventive subject matter, which can include or not include, as suitable, any of the other features described herein, the composition further comprises at least one reaction promoter. Examples of suitable compounds that can be used as reaction promoters include one or more compounds selected from among the group consisting of N-2-aminoethyl-3-aminopropyltriethoxysilane, gamma-aminopropyltriethoxysilane, gamma-aminopropyltrimethoxysilane, aminopropyltrimethoxysilane, bis-gamma-trimethoxysilylpropylamine, N-phenyl-gamma-aminopropyltrimethoxysilane, triaminofunctional trimethoxysilane, gamma-aminopropylmethyldiethoxysilane, gamma-aminopropylmethyldiethoxysilane, methacryloxypropyltrimethoxysilane, methylaminopropyltrimethoxysilane, gamma-glycidoxypropylethyldimethoxysilane, beta-glycidoxypropyltrimethoxysilane, beta-glycidoxyethyltrimethoxysilane, beta-(3,4-epoxycyclohexyl)propyltrimethoxysilane, beta-(3,4-epoxycyclohexyl)ethylmethyldimethoxysilane, isocyanatopropyltriethoxysilane, isocyanatopropylmethyldimethoxysilane, beta-cyanoethyltrimethoxysilane, gamma-acryloxypropyl trimethoxysilane, gamma-methacryloxypropylmethyldimethoxysilane, 4-amino-3,3-dimethylbutyltrimethoxysilane, and N-ethyl-3-trimethoxysilyl-2-methylpropaneamine.

In accordance with a fifth aspect of the present inventive subject matter, there are provided articles that comprise a composition (or a plurality of compositions) in accordance with the first aspect of the present inventive subject matter. In some embodiments in accordance with the fifth aspect of the present inventive subject matter, there are provided articles that consist of (or that consist essentially of) a composition (or a plurality of compositions) in accordance with the first aspect of the present inventive subject matter. Representative examples of articles within the scope of the fifth aspect of the present inventive subject matter include a tape, a thread, a sheet, or a small component.

Among the aspects provided by the present inventive subject matter are structures that comprise one or more lattice structure/operating material regions (each of such region(s) comprising compositions that comprise at least one lattice structure (as described herein) and at least one operating material (as described herein)), which [1] can be provided by applying any of such compositions to any of a wide variety of substrates, [2] can be used in making any of a wide variety of structures, and/or [3] can be used in making sub-structures that can be attached to substrates to make any of a wide variety of structures (e.g., a laminate).

In some instances, lattice structure/operating material regions in accordance with the present inventive subject matter adhere extremely well to substrates (e.g., substrates to which such compositions have been applied, and/or substrates to which such lattice structure/operating material regions (in the form of sub-structures) have been attached). In many instances, the adhesion between a lattice structure/operating material region in accordance with the present inventive subject matter and substrate is so strong that it is nearly impossible to remove the lattice structure/operating material region from the substrate without damaging the substrate.

In accordance with a sixth aspect of the present inventive subject matter, there is provided a structure that comprises [1] at least a first substrate (as described herein), [2] at least a first lattice structure/operating material region (which comprises at least one lattice structure as described herein and at least one operating material as described herein), and [3] at least a first additional region (as described herein) between the first substrate and the first lattice structure/operating material region, as well as methods for making such structures. In some embodiments within this aspect, the at least one additional region makes it easier to remove the first lattice structure/operating material region from the first substrate (if and when there is a need or a desire to do so).

In accordance with a seventh aspect of the present inventive subject matter, there is provided a structure that comprises at least a first lattice structure/operating material region (which comprises at least one lattice structure as described herein and at least one operating material as described herein), as well as methods for making such structures.

In accordance with an eighth aspect of the present inventive subject matter, there is provided a structure that comprises [1] at least a first lattice structure/operating material region (which comprises at least one lattice structure as described herein and at least one operating material as described herein), and [2] at least a first additional region (as described herein), as well as methods for making such structures.

In some of the aspects of the present inventive subject matter, at least one of the at least a first “additional region” can be an interface region, i.e., such structures can comprise at least one lattice structure/operating material region and at least one interface region. In some aspects, an interface region can be in the form of a layer, e.g., such structures can comprise at least a first lattice structure/operating material region and at least one interface region in the form of a layer on the first lattice structure/operating material region.

Structures that comprise at least one lattice structure/operating material region and at least one additional region can tailor (through selection of the chemical nature, the dimensions and/or the positioning) of the at least one additional region) the strength of adhesion between the at least one lattice structure/operating material region and a substrate (or substrates). As noted herein, a substrate can be any element for which there is a desire to apply or attach one or more lattice structure/operating material regions in accordance with the present inventive subject matter, and representative examples of substrates include, e.g., a window, a lens, an automobile windshield, an aircraft windscreen, a sensor, a biomedical device, a lens, a mold, a transfer film, an industrial tape, a label, a die-cut construction, double-sided tape, silicone foam, rubber tape, an in-process liner for easier handling of jumbo rolls, a heat sensitive or non-solvent-castable backing, a non-adhesion lab device, a medical device, a touch screen, an appliance body, a working surface, a wind turbine, a power line, a building drip edge, a fishing line, an aircraft wing, etc. Through the use of one or more additional region in accordance with the present inventive subject matter, direct contact between a lattice structure/operating material region can be reduced, minimized or eliminated, and instead at least a first portion of the one or more addition region (e.g., interface region) is in direct contact with the lattice structure/operating region and at least a second portion of the interface region is in direct contact with the substrate(s)).

In the descriptions herein, the (or each) additional region (e.g., the interface region) can comprise any number of materials (i.e. one or more materials), and can comprise any number of regions (i.e., one or more regions, each comprising one or more materials) (e.g., an additional region can comprise a first layer of a first material and a second layer of a second material, a first surface of the first layer in direct contact with the lattice structure/operating material region, a second surface of the first layer in direct contact with a first surface of the second layer, and a second surface of the second layer in direct contact with the substrate(s)).

Tailoring the strength of adhesion between a lattice structure/operating material region and a substrate can be advantageous for many reasons, e.g., if there is a desire to replace a lattice structure/operating material region on a substrate, i.e., to replace a first lattice structure/operating material region with a second lattice structure/operating material region that has properties that differ from those of the first lattice structure/operating material region, or to provide a fresh lattice structure/operating material region that has properties that are similar to or identical to the properties that the lattice structure/operating material region being removed originally had, e.g., because some aspect of the first lattice structure/operating material region has degraded or changed. While there may be a need or desire to replace a lattice structure/operating material region at some point, it might also be important for the adhesion to be sufficient to avoid any peeling of the lattice structure/operating material region from the substrate before replacement.

A variety of materials and combinations of materials can suitably be used to make an additional region (e.g., an interface region), or to make respective portions of an additional region (e.g., an interface region) in accordance with the present inventive subject matter. A representative group of types of materials that can suitably be used to make an additional region (e.g., an interface region) (or one or more portions thereof) in accordance with the present inventive subject matter are adhesives.

A representative group of types of adhesives that can suitably be used to make an additional region (e.g., an interface region) (or one or more portions thereof) in accordance with the present inventive subject matter are pressure-sensitive adhesives (also known as PSAs). Persons of skill in the art are familiar with a wide variety of pressure-sensitive adhesives, and any of such materials can, as desired, be used in accordance with the present inventive subject matter. Well-known types of pressure-sensitive adhesives include acrylate polymers, rubber (e.g., natural rubber or synthetic thermoplastic elastomer silicone rubber), such materials often being blended with a tackifier to produce permanent tack (“grabbing power”) at room temperature. Additional well-known types of pressure-sensitive adhesives include rubber/resin formulations (i.e., formulations that combine natural or synthetic rubber with tackifying resins, oils, antioxidants, or other ingredients as needed), acrylic adhesives (which can either be solvent- or water-based, and are formulated by reacting monomers with the desired properties, which are then typically crosslinked to form the type of polymer needed; monomers are the building blocks of polymers and are considered to be either “soft” or “hard; the combination of hard and soft monomers can be adjusted based on the level of adhesive (polymer) performance needed), and silicone adhesives (e.g., consisting of silicone polymers that provide adhesion to silicon and other hard-to-adhere-to materials). It should be recognized that the above list is only representative, and that any suitable material can be used to make an additional region (e.g., an interface region).

An additional region (e.g., an interface region) can be formed in any suitable way, e.g., by coating a substrate (or at least a portion thereof) with a material that forms a suitable additional region (e.g., interface region), e.g., by coating the substrate (or at least a portion thereof) with a pressure-sensitive adhesive.

An additional region (e.g., an interface region) can be formed in a variety of other ways, e.g., it can be applied to a releasable film or releasable layer and then top-coated with a lattice structure-forming coating (e.g., a composition that can be used to form an additional region can be coated on a releasable film or releasable layer, and then a composition that can be used to form a lattice structure as described herein can be applied only the additional region) to form a structure that can later be applied to a substrate (or substrates).

Persons of skill in the art are familiar with a wide variety of releasable films and releasable layers (and materials that can be used to form releasable films or releasable layers), and any such releasable film or releasable layer can be used in accordance with the present inventive subject matter. The expression “film” in the expression “releasable film” and the expression “layer” in the expression “releasable layer” do not connote flatness, thinness, aspect ratio (length divided by thickness, width divided by thickness and/or surface area divided by thickness), or uniformity of thickness, nor does either expression indicate that the “releasable film” or “releasable layer” covers the entirety of a surface or structure with which it is in direct contact or indirect contact (e.g., on which it is located).

As a group of representative examples, a releasable film or layer can be a pressure-sensitive adhesive which is a type of non-reactive adhesive, which forms a bond when pressure is applied to bond the adhesive with the adherend. No solvent, water, or heat is needed to activate the adhesive.

As another group of representative examples, a releasable film or layer can be a selectively soluble adhesive, e.g., a type of adhesive that forms a bond when dried or cured, wherein the bond can be dissolved by a first type of solvent but not by a second type of solvent. A first type of solvent might be an aromatic solvent, such as xylene or toluene, yet the second type of solvent might be a polar solvent such as water or an alcohol.

As another group of representative examples, a releasable film or layer can be a temperature-sensitive adhesive, wherein the bond weakens when heated to a sufficiently high temperature or when cooled to a suitably cold temperature.

As another group of representative examples, a releasable film or layer can be electrostatic in nature, wherein a bond forms on contact with a suitable substrate or other structure, yet with sufficient force the releasable film or layer can be removed from the substrate or other structure.

An additional region can be formed and then coated on two of its surfaces (e.g., on opposite sides of the additional region) with a lattice structure-forming coating (e.g., a composition that can be used to form a lattice structure as described herein) or with different lattice structure-forming coatings (i.e., such that a resulting lattice structure on a first surface of the additional region will be of a chemical structure that differs from the chemical structure of a resulting lattice structure on a second surface of the additional region) on the respective surfaces of the additional region, to provide a structure that can later be applied to a substrate (or substrates).

Additional regions (e.g., interface regions) as described herein can have good resistance to the elements (e.g., ambient materials and/or conditions, e.g., gases and/or liquids and/or conditions (temperature, pressure, etc.) in the surrounding environment), the operating material(s) and/or any selected materials (e.g., liquids). In some embodiments according to the present inventive subject matter, which can include or not include, as suitable, any of the other features described herein, a material (or combination of materials) used to make an additional region (or regions) and/or a formed additional region(s) is/are insoluble to an uncured lattice structure (e.g., a lattice structure that is being formed in the vicinity of or in contact with the additional region (which can itself be in the process of being formed), but still have good mutual adhesion (i.e., the additional region has good adhesion with the lattice structure and the lattice structure has good adhesion with the additional region).

### BRIEF DESCRIPTION OF THE DRAWING FIGURES

FIGS. 1 and 2 depict simulated skeletal and more detailed structures of HDPE.

FIG. 3 figuratively shows that linear polymers may :form closely packed crystals.

FIGS. 4 and 5 show simulated skeletal and more detailed structures of LDPE.

FIG. 6 illustrates a skeletal structure of a network polymer with a high cross-link density.

FIGS. 7 and 8 illustrate rotated views of an operating material-filled tetrahedral lattice structure in accordance with the present inventive subject matter, comprising tetra-functional nuclear moieties and di-functional elongated moieties.

FIG. 9 illustrates an operating material-filled cubic lattice structure in accordance with the present inventive subject matter, comprising hex-functional nuclear moieties and di-functional elongated moieties.

FIG. 10 schematically depicts a structure 30 that comprises a first lattice structure/operating material region 31 and a first additional region 32.

FIG. 11 schematically depicts a structure 40 that comprises a first lattice structure/operating material region 41, a first additional region 42 and a first substrate 47.

FIG. 12 schematically depicts a structure 50 that comprises a first lattice structure/operating material region 51, a first additional region 52 and a releasable film 57.

FIG. 13 schematically depicts a structure 60 that comprises a first lattice structure/operating material region 61, a first additional region 62, a releasable film 67, a second additional region 70 and a second lattice structure/operating material region 71.

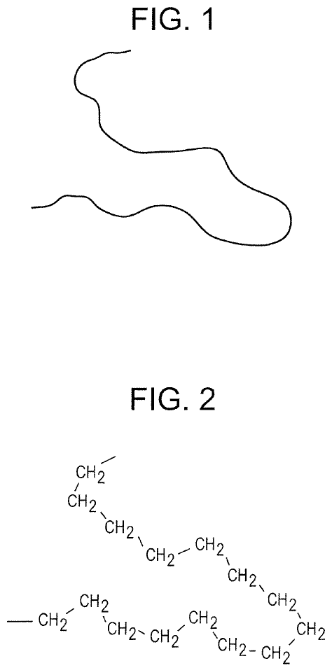

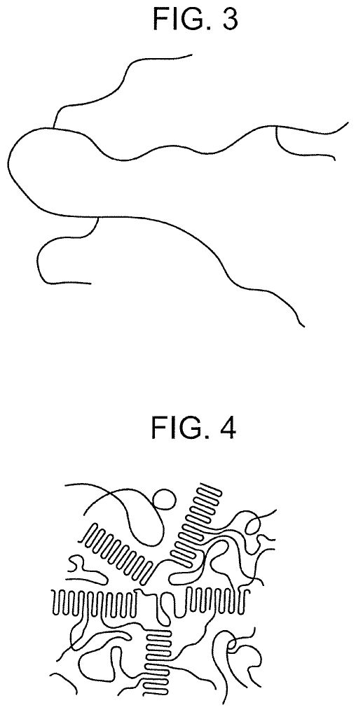

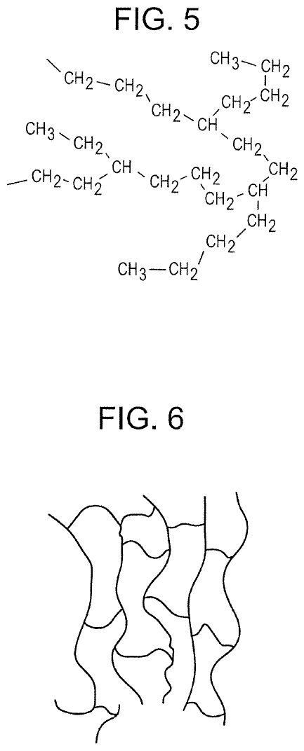

### DETAILED DESCRIPTION OF THE INVENTIVE SUBJECT MATTER

Where an expression is defined herein in terms of the meaning of the expression in the singular, the definition applies also to the plural (and vice-versa, i.e., an expression defined herein in the plural, the definition applies also to the singular). Definitions of one form of an expression apply to the same expression in a different form of the word or words.

In some aspects, the present inventive subject matter relates to lattice structures, compositions that each comprise at least one lattice structure and one or more operating materials, compositions that each can be used in making one or more lattice structures (and/or in making a composition that comprises one or more lattice structures and one or more operating materials), structures that comprise one or more regions that each comprise at least one lattice structure and at least one operating material, and methods of making all of such things. The disclosure herein describes such lattice structures in terms of their chemical natures. In some aspects of the present inventive subject matter, the chemical nature of such lattice structures is described in terms of nuclear moieties and elongated moieties which are analogous to building blocks that can together build large chemical structures (i.e., lattices), with the nuclear moieties analogous to nodes and the elongated moieties analogous to connectors extending between nodes. In some aspects herein, the lattice structures are therefore described in terms of the nuclear moieties and the elongated moieties, and in some aspects, the nuclear moieties and the elongated moieties are described in terms of representative chemical compounds (nuclear moiety precursor compounds and elongated moiety precursor compounds) that can be reacted to generate the lattice structures (whereby the nuclear moieties “correspond” to respective nuclear moiety precursor compounds and are not identical to their respective corresponding nuclear moiety precursor compounds, and the elongated moieties “correspond” to respective elongated moiety precursor compounds and are not identical to their respective corresponding elongated moiety precursor compounds). The lattice structures in accordance with the present invention are not limited to products of specific reactants. In view of all of this, the expressions used herein to describe the subject matter within the various aspects of the present inventive subject matter are defined in detail below.

The expression “bonded,” as used herein, refers to any type of chemical bonding, including ionic bonding, metallic bonding, van der Waals forces, covalent bonding, hydrogen bonding, etc. The expression “bond,” as used herein, refers to any bond (an ionic bond, a metallic bond, a van der Waals force, a covalent bond, a hydrogen bond, etc.), between two atoms. Thus, the expression “bond” (and the expression “chemical bond”), as used herein, refers to a lasting affinity between atoms, ions or molecules that enables the formation of chemical compounds and moieties. A bond may result from the electrostatic force of attraction between oppositely charged ions, as in ionic bonds, or through the sharing of electrons, as in covalent and metallic bonds. There are strong or primary bonds, such as metallic, covalent or ionic bonds, and weak or secondary bonds, such as dipole-dipole interactions, the London dispersion force and hydrogen bonding.

The expression “directly bonded”, as used herein (e.g., in the expression “directly bonded to one or more resultant elongated moieties”), means that one or more bond extends from [1] an entity (the “first entity”, which is an atom or a moiety), to [2] another entity (the “second entity”, also an atom or a moiety) to which the first entity is directly bonded, i.e, there are no intervening atoms between the first entity and the second entity. A statement that a first moiety is “directly bonded” to a second moiety means that at least one atom in the first moiety is directly bonded to at least one atom in the second moiety. A statement that a moiety is “directly bonded” to an atom (or a statement that an atom is “directly bonded” to a moiety) means that the atom is directly bonded to at least one atom in the moiety.

The expression “indirectly bonded”, as used herein (e.g., a first entity (an atom or a moiety) is “indirectly bonded” to a second entity (an atom or a moiety) means that the first entity is not directly bonded to the second entity, but the first entity is bonded to the second entity via one or more intervening atoms, i.e., starting from the first entity, a path can be traced to the second entity via atoms and atom-to-atom bonds (each such atom-to-atom bond connecting one respective atom to another respective atom).

The expression “chemical compound,” as used herein, (as well as the expression “compound,” as used herein) refers to an arrangement of atoms that are each bonded (by ionic bonding, metallic bonding, van der Waals force, covalent bonding, and/or hydrogen bonding), directly (i.e., with no intervening atoms) or indirectly (i.e., via one or more other atoms), to each other atom in the chemical compound.

The expression “moiety” (e.g., “nuclear moieties” and “elongated moieties”), as used herein, refers to an arrangement of atoms that are each bonded (by ionic bonding, metallic bonding, van der Waals force, covalent bonding, and/or hydrogen bonding), directly (i.e., with no intervening atoms) or indirectly (i.e., via one or more other atoms), to each other atom in the moiety. A “moiety,” as used herein, consists of some or all of the atoms in a chemical compound, and the bonds that connect each of the atoms in the moiety to one or more other atom(s) in the moiety.

The expression “chemical structure,” as used herein, refers to an arrangement of atoms and bonds (e.g., ionic bonds, metallic bonds, van der Waals forces, covalent bonds, hydrogen bonds, etc.) in a compound or a moiety, i.e., precisely which atoms are bonded to what other atoms, and the nature of each of such bonds.

A “chemical structure” can thus refer to an arrangement of actual atoms and bonds (i.e., a single specific compound or portion of a compound), or can refer generically to any arrangement of atoms and bonds that has all of the features specified for the chemical structure (i.e., any compound or portion of a compound that has the specified arrangement of atoms and bonds, e.g., any ethyl group). As an example where “chemical structure” refers to an actual arrangement, one might describe an actual reaction by saying that “two grams of [a first compound] were mixed in a beaker with two grams of [a second compound], and the first and second compounds underwent a chemical reaction to form a third compound, the third compound comprising [1] a moiety that corresponds to a moiety in the first compound, and [2] a moiety that corresponds to a moiety in the second compound. As an example where a “chemical structure” refers generically to any arrangement of atoms and bonds that has all of the features specified for the chemical structure, one might state that in order to form the third compound, one can react a quantity of the first compound with a quantity of the second compound under specific conditions and/or in the presence of one or more other materials. Moreover, one might analyze a chemical compound and determine that the chemical compound comprises a moiety that has a particular chemical structure (i.e., without knowledge as to the exact way by which the chemical compound came to exist, e.g., whether it resulted from a reaction involving any chemical compound that comprises the entirety of the chemical structure).

The expression “chemical structure” thus encompasses [1] chemical structures that refer to all of the atoms that are bonded together (and the bonds among such atoms), i.e., “chemical compounds” (or “compounds”), as well as [2] chemical structures that together make up a subset of the atoms that are bonded together (and the bonds among such subset of atoms). For example, a moiety that is part of a chemical compound has a chemical structure, and the entire chemical compound (of which the moiety is a part) comprises the moiety but has a different overall chemical structure.

The expression “chemical structure in a compound,” as used herein, can refer to [1] the entirety of the compound, or [2] a portion of the compound. Thus, a statement herein that a chemical structure is “in a compound” means that the compound comprises the chemical structure, and can have an overall chemical structure that differs from the chemical structure (in that it comprises one or more additional atoms and/or bonds).

The expression “chemical structure,” as used herein, does not necessarily refer to geometrical characteristics, i.e., a “chemical structure” in a moiety can be the same as a “chemical structure” in a compound, even though geometrical characteristics of the chemical structure in the moiety may differ from geometrical characteristics of the chemical structure in the compound.

The expression “lattice structure,” as used herein, refers to a three-dimensional arrangement of chemical moieties (including but not limited to instances in which the chemical moieties together make up a somewhat repeating arrangement, e.g., to form a cubic lattice, a tetrahedral lattice or any Bravais lattice), each chemical moiety comprising an arrangement of atoms, to provide a crystalline, semi-crystalline and/or quasi-crystalline arrangement. For example, in some aspects, the present inventive subject matter relates to lattice structures that each comprise a plurality of nuclear moieties and a plurality of elongated moieties, with some or all of the nuclear moieties bonded (by ionic bonding, metallic bonding, van der Waals force, covalent bonding, and/or hydrogen bonding) to at least three elongated moieties, and some or all of the elongated moieties bonded (by ionic bonding, metallic bonding, van der Waals force, covalent bonding, and/or hydrogen bonding) to at least two nuclear moieties.

The expression “nuclear moiety,” as used herein, refers to a moiety that is bonded (by ionic bonding, metallic bonding, van der Waals force, covalent bonding, and/or hydrogen bonding) to at least three respective elongated moieties. The term “nuclear” is not intended to specify any particular atomic or chemical feature, and does not characterize a moiety in any particular way, except that a nuclear moiety is selected from among the arrangements of atoms that are characterized herein as nuclear moieties.

The expression “nuclear moiety precursor compound,” as used herein, refers to a chemical compound that comprises at least part of a nuclear moiety (a nuclear moiety consists of or comprises a chemical structure that is the same as at least part of a chemical structure in a corresponding nuclear moiety precursor compound, and/or in which atoms are re-arranged). A nuclear moiety precursor compound may contain one or more additional atoms, and/or one or more fewer atoms, and/or one or more atoms may be substituted for, in comparison to a “corresponding” nuclear moiety.

The expression “plurality of nuclear moiety precursor compounds,” as used herein, refers to two or more chemical compounds (nuclear moiety precursor compounds) that are the same or different (i.e., a “plurality of nuclear moiety precursor compounds” can consist of a plurality of compounds of the same chemical structure, or can comprise any respective numbers of compounds of each of two or more chemical structures).

The expression “elongated moiety,” as used herein, refers to a moiety that is bonded (by ionic bonding, metallic bonding, van der Waals force, covalent bonding, and/or hydrogen bonding) to at least two respective nuclear moieties. The term “elongated” is not intended to specify any particular or generic geometrical feature, and does not characterize a moiety in any particular way, except that an elongated moiety is selected from among the arrangements of atoms that are characterized herein as elongated moieties.

The expression “elongated moiety precursor compound,” as used herein, refers to a chemical compound that comprises at least part of an elongated moiety (an elongated moiety consists of or comprises a chemical structure that is the same as a chemical structure in a corresponding elongated moiety precursor compound, and/or in which atoms are re-arranged). An elongated moiety precursor compound may contain one or more additional atoms, and/or one or more fewer atoms, and/or one or more atoms may be substituted for, in comparison to a “corresponding” elongated moiety.

The expression “plurality of elongated moiety precursor compounds,” as used herein, refers to two or more chemical compounds (elongated moiety precursor compounds) that are the same or different (i.e., a “plurality of elongated moiety precursor compounds” can consist of a plurality of compounds of the same chemical structure, or can comprise any respective numbers of compounds of each of two or more chemical structures).

The expression “functional moiety” is used herein (with regard to a nuclear moiety precursor compound or an elongated moiety precursor compound) in accordance with its well known meaning to refer to a moiety (or functional group) that is among the many moieties that are recognized and classified as groups of bonded atoms. In particular, the expression “functional moiety” is used herein to refer to a moiety (e.g., a portion of a nuclear moiety precursor compound or a portion of an elongated moiety precursor compound) that is known to readily undergo chemical reaction with one or more specific other functional moieties (or any of a range of moieties).

The expression “bonded-functional moiety” is used herein (with regard to a nuclear moiety or an elongated moiety) to refer to the portion of a functional moiety that corresponds to a functional moiety, e.g., the portion from a functional moiety that remains (in a nuclear moiety or an elongated moiety) after a reaction between a nuclear moiety precursor compound and an elongated moiety precursor compound (i.e., a reaction that results in an atom of the nuclear moiety precursor compound becoming bonded to an atom of the elongated moiety precursor compound).

The expression “corresponds” (and the related expression “corresponding”), as used herein, refers to a comparison between [1] a first chemical structure consisting of specific atoms (namely, a chemical compound or a moiety), and [2] a second chemical structure (namely, a moiety), in which at least a portion of the first chemical structure [i] is the same as the entirety of the second chemical structure, or [ii] differs from the second chemical structure by the removal or one or more atoms, and/or the addition of one or more atoms, and/or the re-arrangement of one or more atoms, and/or the conversion of one or more bonds to a respective different bond (e.g., conversion of a double bond to a single bond). Some or all of the atoms in the second chemical structure can be the same individual atoms (i.e., actual atoms) as those in the first chemical structure, or merely an analogous arrangement of atoms and bonds in the second chemical structure can be in the first chemical structure (i.e., none of the atoms in the first and second chemical structures are the same individual atoms, but instead some or all of the atoms in the second chemical structure are the same elements, arranged in the same way, as the elements in at least a portion of the first chemical structure, e.g., if the second chemical structure is characterized as any ethyl group and the first chemical structure is characterized as any ethane compound).

As an example of the atoms in the second chemical structure being the same individual actual atoms (arranged in the same way) as those in the first chemical structure, where a “precursor compound” is involved in a chemical reaction (actual or theoretical, i.e., the same individual atoms or the same generic arrangement of atoms) that results in a product (or that would result in a product), such that the product contains a “resultant moiety” that consists of atoms that were in the precursor compound, the precursor compound “corresponds” to the resultant moiety, and the resultant moiety “corresponds” to the precursor compound; in addition, [1] the precursor compound is characterized as “a corresponding precursor compound” relative to the resultant moiety, and [2] the resultant moiety is characterized as “a corresponding resultant moiety” relative to the precursor compound. As noted above, the terminology herein relates to actual chemical structures as well as to generic chemical structures, and so the expressions “precursor” and “resultant” are used in an actual sense or in a generic sense, and are used to define chemical structures, not to imply that a resultant chemical structure must have actually resulted from a reaction involving the precursor chemical structure. In the example set forth earlier in this paragraph, since the atoms in the resultant moiety (second chemical structure) are the same atoms (arranged in the same way) as those in the precursor compound (first chemical structure), the precursor compound also “corresponds directly” to the resultant moiety, and the resultant moiety “corresponds directly” to the precursor compound; also [1] the precursor compound can further be characterized as “a directly corresponding precursor compound” relative to the resultant moiety, and [2] the resultant moiety can further be characterized as “a directly corresponding resultant moiety” relative to the precursor compound. That is, a second chemical structure and a first chemical structure “directly correspond” if the second chemical structure differs from the first chemical structure only by the removal of one or more atom(s) from the first chemical structure, and/or by the conversion of one or more bonds (e.g., from a double bond to a single bond), and/or by the re-arrangement of atoms. If on the other hand, the second chemical structure differs from the first chemical structure by the addition of one or more atoms to the first chemical structure, and/or the substitution of one or more atoms in the first chemical structure (optionally in addition to the “directly” corresponding changes, i.e., removal of one or more atom(s) from the first chemical structure, and/or conversion of one or more bonds (e.g., from a double bond to a single bond), and/or re-arrangement of atoms), the precursor compound “corresponds indirectly” to the resultant moiety; the resultant moiety “corresponds indirectly” to the precursor compound; the precursor compound can he characterized as “an indirectly corresponding precursor compound” relative to the resultant moiety, and the resultant moiety can be characterized as “an indirectly corresponding resultant moiety” relative to the precursor compound.

As an example of merely the arrangement of atoms and bonds in the second chemical structure being in the first chemical structure (i.e., as a result of a theoretical reaction, with the chemical structures described in a generic sense), where a second structure consists of an ethyl group, such second structure corresponds to any ethane compound (because each comprises two carbon atoms and five hydrogen atoms bonded in similar ways). Thus, for example, the expression “nuclear moiety corresponds to a compound selected from among [a group of chemical compounds]”), as used herein, means that the nuclear moiety, in its entirety, consists of a chemical structure [a] that is identical to a chemical structure in a portion (or an entirety) of one of the chemical compounds in the recited group of chemical compounds, or [b] differs from a chemical structure in a portion (or an entirety) of one of the chemical compounds in the recited group of chemical compounds in one or more of the other ways described above (and the expression “[a chemical compound] corresponds to a nuclear moiety” means that a chemical structure in the compound [a] is identical to the nuclear moiety), or [b] differs from the nuclear moiety in one or more of the other ways described above; an example of where the expression “nuclear moiety directly corresponds to a compound selected from among [a group of chemical compounds]” (and the expression “[a chemical compound] corresponds to a nuclear moiety”) would apply herein is where the nuclear moiety, in its entirety, consists of a chemical structure that is identical to a chemical structure in a portion (or an entirety) of one of the chemical compounds in the recited group of chemical compounds.

Thus, for example, where a nuclear moiety, in its entirety, consists of a chemical structure that is identical to a chemical structure in a portion (or an entirety) of one of the chemical compounds in a recited group of chemical compounds, the expression “nuclear moiety directly corresponds to a compound selected from among [a group of chemical compounds]”) would apply.

In accordance with the terminology employed in the present specification, a plurality of chemical compounds (comprising a plurality of nuclear moiety precursor compounds and a plurality of elongated moiety precursor compounds) can be reacted to result in a lattice structure that comprises [1] a plurality of resultant nuclear moieties that correspond to respective nuclear moiety precursor compounds, and [2] a plurality of resultant elongated moieties that correspond to respective elongated moiety precursor compounds. Accordingly, in the present specification, a “corresponding resultant nuclear moiety” (with respect to a nuclear moiety precursor compound) refers to a nuclear moiety which [1] directly corresponds to the nuclear moiety precursor compound or indirectly corresponds to the nuclear moiety precursor compound, and [2] is included in the lattice structure. Similarly, a resultant nuclear moiety that “corresponds to a nuclear moiety precursor compound” refers to a nuclear moiety which [1] directly corresponds to the nuclear moiety precursor compound or indirectly corresponds to the nuclear moiety precursor compound, and [2] is included in the lattice structure. Thus, in many cases, a resultant nuclear moiety differs from its “directly corresponding” nuclear moiety precursor compound, i.e., the nuclear moiety precursor compound to which it “directly corresponds” by the absence (e.g., by removal during a chemical reaction) of one or more atoms and/or the conversion of one or more double bonds to one or more respective single bonds and/or the conversion of one or more triple bonds to one or more respective double bonds, as well as being directly bonded to one or more resultant elongated moieties). Thus, in some instances, a resultant nuclear moiety consists of some or all of the atoms in its corresponding nuclear moiety precursor compound, and a resultant elongated moiety consists of some or all of the atoms in its corresponding elongated moiety precursor compound.

Likewise, a “corresponding nuclear moiety precursor compound” with respect to a resultant nuclear moiety, refers to the nuclear moiety precursor compound to which the resultant nuclear moiety (which is included in a lattice structure) corresponds (e.g., the nuclear moiety precursor compound that included the atoms, some or all of which are in the resultant nuclear moiety). Similarly, a “nuclear moiety precursor compound that corresponds to a resultant nuclear moiety” refers to the nuclear moiety precursor compound to which the resultant nuclear moiety (which is included in a lattice structure) corresponds.

The definitions in the preceding four paragraphs apply similarly with respect to elongated moiety precursor compounds and resultant elongated moieties (i.e., the preceding four paragraphs, with each occurrence of “nuclear” being replaced by “elongated,” also are applicable in the present specification).

In accordance with the terminology employed in the present specification, a plurality of chemical compounds (comprising a plurality of nuclear moiety precursor compounds and a plurality of elongated moiety precursor compounds) can be reacted to result in a lattice structure that comprises [1] a plurality of nuclear moieties that correspond (respectively) to the nuclear moiety precursor compounds, and [2] a plurality of elongated moieties that correspond (respectively) to the elongated moiety precursor compounds.

For example, in some cases where a plurality of actual nuclear moiety precursor compounds and a plurality of actual elongated moiety precursor compounds react with each other by condensation reactions (i.e., each reaction proceeding in a step-wise fashion to produce a product, usually in equilibrium and with the release of water, ammonia, ethanol, acetic acid, or other such species, and typically proceeding in acidic or basic conditions and/or in the presence of a catalyst):
[A] the difference between each nuclear moiety precursor compound and its corresponding nuclear moiety is the removal of hydrogen atoms from the nuclear moiety precursor compound (i.e., one hydrogen atom for each elongated moiety to which it has become bonded through the reaction), and the difference between each elongated moiety precursor compound and its corresponding elongated moiety is the removal of hydrogen atoms and oxygen atoms from the elongated moiety precursor compound (i.e., one hydrogen atom and one oxygen atom for each nuclear moiety to which it has become bonded through the reaction),
   or
[B] the difference between each nuclear moiety precursor compound and its corresponding nuclear moiety is the removal of hydrogen atoms and oxygen atoms from the nuclear moiety precursor compound (i.e., one hydrogen atom and one oxygen atom for each elongated moiety to which it has become bonded through the reaction), and the difference between each elongated moiety precursor compound and its corresponding elongated moiety is the removal of hydrogen atoms from the elongated moiety precursor compound (i.e., one hydrogen atom for each nuclear moiety to which it has become bonded through the reaction).

In some situations where a plurality of actual nuclear moiety precursor compounds and a plurality of actual elongated moiety precursor compounds react with each other by addition reactions (i.e., where two or more molecules combine to form a larger one (the adduct) and involve compounds having multiple bonds, as examples, molecules with carbon-carbon double bonds (alkenes) or with triple bonds (alkynes), hetero double bonds like carbonyl (C═O) groups, or imine (C═N) groups, and where such reactions can be electrophilic addition (polar) reactions, nucleophilic addition (polar) reactions, free-radical (non-polar) addition reactions and/or cycloaddition (non-polar) reactions):
[A] the difference between each nuclear moiety precursor compound and its corresponding nuclear moiety is the conversion of one or more bonds to a lesser type of bond (e.g., conversion of a double bond to a single bond, or conversion of a triple bond to a double bond) in the nuclear moiety precursor compound (i.e., one bond conversion for each elongated moiety to which it has become bonded through the reaction),
   or

[B] the difference between each elongated moiety precursor compound and its corresponding elongated moiety is the conversion of one or more bonds to a lesser type of bond (e.g., conversion of a double bond to a single bond, or conversion of a triple bond to a double bond) in the elongated moiety precursor compound (i.e., one bond conversion for each elongated moiety to which it has become bonded through the reaction).

The expression “nuclear moiety precursor compound functional moiety,” as used herein, refers to a functional moiety in a nuclear moiety precursor compound.

The expression “nuclear moiety bonded-functional moiety,” as used herein, refers to a chemical structure (in a nuclear moiety) that corresponds to a nuclear moiety precursor compound functional moiety of a nuclear moiety precursor compound that corresponds to the nuclear moiety.

The expression “elongated moiety precursor compound functional moiety,” as used herein, refers to a functional moiety in an elongated moiety precursor compound.

The expression “elongated moiety bonded-functional moiety,” as used herein, refers to a chemical structure (in an elongated moiety) that corresponds to an elongated moiety precursor compound functional moiety of an elongated moiety precursor compound that corresponds to the elongated moiety.

Respective functional moieties in nuclear moiety precursor compounds are capable of reacting with respective functional moieties in elongated moiety precursor compounds, and for each reaction between [1] a nuclear moiety precursor compound, and [2] an elongated moiety precursor compound, such that a chemical bond is formed (or chemical bonds are formed) between the corresponding nuclear moiety and the corresponding elongated moiety, [a] one or more atoms and/or bonds that was/were in the nuclear moiety precursor compound, and/or [b] one or more atoms and/or bonds that was/were in the elongated moiety precursor compound, is/are not included in the resulting lattice structure (and in some instances, the lattice structure can include atoms and/or bonds that were not in the nuclear moiety precursor compound or the elongated moiety precursor compound). In other words, a “lattice structure” does not comprise the entireties (i.e., all of the atoms and all of the bonds) of each of the respective chemical compounds that are reacted to form the lattice structure, and in the terminology used in the present specification, “elongated moieties” and “nuclear moieties” encompass those atoms, from their respective precursor chemical compounds (or moieties), that remain after actual reaction (or that would remain after a theoretical reaction, in the generic sense) to form a lattice structure (i.e., that are in the lattice structure). Similarly, in the terminology used herein, for each reaction between [1] a nuclear moiety precursor compound, and [2] an elongated moiety precursor compound, such that a chemical bond is formed (or chemical bonds are formed) between the corresponding nuclear moiety and the corresponding elongated moiety, [a] one or more atoms and/or bonds that was/were in the nuclear moiety precursor compound functional moiety, and/or [b] one or more atoms and/or bonds that was/were in the elongated moiety precursor compound functional moiety, is/are not included in the resulting lattice structure (and thus is/are not included in the resulting nuclear moiety bonded-functional moiety and/or the resulting elongated moiety bonded-functional moiety, i.e., the difference between “functional moiety” and “bonded-functional moiety” is that a “functional moiety” (in a nuclear moiety precursor compound or an elongated moiety precursor compound) is a reactive moiety, whereas a “bonded-functional moiety” (in a nuclear moiety or an elongated moiety) is what remains of the functional moiety after reaction). As described above, lattice structures are described herein generically, in terms of chemical structures, including descriptions of moieties that correspond to compounds (nuclear moiety precursor compounds or elongated moiety precursor compounds) and/or that correspond to moieties or functional moieties of such compounds, i.e., without implying that the lattice structures necessarily resulted from actual reaction of specified compounds or moieties.

Statements herein that each of a plurality of moieties “correspond” to a respective one of a group of compounds means that each individual moiety corresponds to some member of the group, i.e., each of the moieties can correspond to the same chemical structure, or any respective numbers of the moieties can correspond to each of two or more chemical structures (e.g., some of the moieties are of a first chemical structure, some of the moieties are of a second chemical structure, and some of the moieties are of a third chemical structure). For example, the expression “each of the plurality of nuclear moieties corresponding to one of the nuclear moiety precursor compounds,” as used herein, indicates that any number of the nuclear moieties can be of the same chemical structure or of different chemical structures, and [1] each nuclear moiety corresponds (as defined above) to a respective actual nuclear moiety precursor compound, or [2] each nuclear moiety corresponds to one of the chemical structures within the scope of the nuclear moiety precursor compounds (and analogously, the expression “each of the plurality of elongated moieties corresponding to one of the elongated moiety precursor compounds,” as used herein, indicates that any number of the elongated moieties can be of the same chemical structure or of different chemical structures, and [1] each elongated moiety corresponds (as defined above) to a respective actual elongated moiety precursor compound, or [2] each elongated moiety corresponds to one of the chemical structures within the scope of the elongated moiety precursor compounds).

Thus, a statement herein that “each of the nuclear moieties corresponds to a respective compound selected from among the group consisting of [a group of compounds],” means that each of the nuclear moieties can correspond to the same chemical compound, or that respective numbers of the nuclear moieties can correspond to each of two or more chemical structures, e.g., some are of a first chemical structure, some are of a second chemical structure, and some are of a third chemical structure (and similarly with respect to other analogous statements, e.g., “each of the elongated moieties corresponds to a respective compound selected from among the group consisting of [a group of compounds]”).

A statement herein that “each of the nuclear moiety precursor compounds is selected from among the group consisting of [a group of compounds],” means that the respective nuclear moiety precursor compounds can all be the same type of compound, or that respective numbers of the nuclear moiety precursor compounds can be of each of two or more chemical structures (and similarly with respect to other analogous statements, e.g., “each of the elongated moiety precursor compounds is selected from among the group consisting of [a group of compounds]”).

A statement herein that “each of the nuclear moieties comprises at least one nuclear moiety bonded-functional moiety selected from among the group consisting of [a group of moieties]” means that each of such nuclear moieties comprises one or more nuclear moiety bonded-functional moieties, and where a nuclear moiety comprises two or more nuclear moiety bonded-functional moieties, each of the bonded-functional moieties may be the same, each of the bonded-functional moieties may differ, or any number of the bonded-functional moieties may be respective different nuclear moiety bonded-functional moieties (and similarly with respect to other analogous statements, e.g., “each of the nuclear moiety precursor compounds comprises at least one nuclear moiety precursor compound functional moiety selected from among the group consisting of [a group of functional moieties]”, “each of the elongated moieties comprises at least one elongated moiety bonded-functional moiety selected from among the group consisting of [a group of bonded-functional moieties]”. “each of the elongated moiety precursor compounds comprises at least one elongated moiety precursor compound functional moiety selected from among the group consisting of [a group of functional moieties], etc.”).

The expression “cell defined by respective atoms of the lattice structure,” as used herein, refers to a region [1] that is within a lattice structure (as defined herein), and [2] does not include any atom of a nuclear moiety or any atom of an elongated moiety. The expression “operating material compound within a cell” (and similar or analogous expressions), as used herein, refers to one or more operating material compounds in such a region within a lattice structure.

The expression “plurality of operating material compounds,” as used herein, means at least two chemical compounds which are each among the types of chemical compounds from which operating materials can be selected, and [1] are each of the same chemical structure, or [2] any respective quantities are of each of two or more different chemical structures.

The expression “operating material compounds,” as used herein (e.g., in the expression “supplying at least [1] nuclear moiety precursor compounds, [2] elongated moiety precursor compounds, and [3] operating material compounds to a space,” or the expression “removing from the space a composition comprising at least a first lattice structure and a plurality of said operating material compounds,” or the expression “at least some of said operating material compounds are in respective cells of the first lattice structure” can refer to two or more chemical compounds which [1] are each of the same chemical structure, or [2] any respective quantities are of each of two or more different chemical structures (e.g., [1] the operating material compounds are all of the same chemical structure, or [2] the operating material compounds comprise a mixture consisting of two parts by weight of a first chemical structure, three parts by weight of a second chemical structure and five parts by weight of a third chemical structure, etc.).

The expression “one or more operating material compounds” means a single operating material compound or a plurality of operating material compounds [1] which are each of the same chemical structure, or [2] which comprise any respective quantities are of each of two or more different chemical structures.

The expression “plurality of operating material compounds within respective cells defined by the lattice structure,” as used herein, means that [1] each of the plurality of operating material chemical compounds is within a respective cell defined by the lattice structure (i.e., each of the plurality of operating material compounds is in a different cell), or [2] any number of the operating material compounds are in at least one of the cells.

The operating material or plurality of operating materials effect formation of the lattice structure, as is often the case in the formation of ordinary crystalline lattice structures. In the present inventive subject matter, at least one operating material is retained in the crystalline structure.

The expression “supplying [respective compounds] to a space,” e.g., the expression “supplying [1] nuclear moiety precursor compounds, [2] elongated moiety precursor compounds, and [3] operating material compounds to a space,” as used herein, encompasses any activity (or combination of activities) by which at least some of the respective compounds can come into contact with each other (and does not require any degree of stirring, shaking, blending and/or other activity that would increase uniformity of dispersion of any or all compounds among any other compounds). Representative examples include (and are not limited to) supplying (intermittently or continuously, or any combination thereof, at any rate, in batches or all at once) respective compounds (all compounds at the same time, all or part of individual respective compounds in any sequence, respective portions (or batches) of respective compounds in any order and/or any portions simultaneously, etc.) to a container, a reaction chamber, etc.

The expression “accounts for at least [a particular] weight percent,” as used herein (e.g., in the expression “wherein the operating material accounts for at least 40 weight percent of the composition”) means that the composition comprises at least the specified weight percent of the specified material (e.g., operating material) among the entire composition (i.e., at least the specified percentage of the composition is the specified material, e.g., the expression “wherein the operating material accounts for at least 40 weight percent of the composition” means that at least 40 weight percent of the composition is operating material).

The expression “in contact”, as used in the present specification, means that the first structure which is “in contact” with a second structure can be in direct contact with the second structure, or can be separated from the second structure by one or more intervening structures (i.e., in indirect contact), where the first and second structures, and the one or more intervening structures each have at least one surface which is in direct contact with another surface selected from among surfaces of the first and second structures and surfaces of the one or more intervening structures.

The expression “direct contact”, as used in the present specification, means that the first structure which is “in direct contact” with a second structure is touching the second structure and there are no intervening structures between the first and second structures at least at some location.

In some aspects, the present inventive subject matter relates to three-dimensional polymer lattice structures (crystalline, semi-crystalline or quasi-crystalline), which are capable of holding operating material (e.g., at least 20 percent by weight, at least 30 percent by weight, at least 40 percent by weight, at least 50 percent by weight), and that are capable of holding at least some of such operating material (e.g., 70 percent of such operating material, 80 percent of such operating material, 90 percent of such operating material) at least for some period of time, and preferably for long periods of time, e.g., at least one month.

In some embodiments according to the present inventive subject matter, including some embodiments that include or do not include any of the features as discussed herein, the lattice element(s) is/are substantially covalently bonded and formed in sufficient operating material to allow crystallization as a 3D lattice. There may be other materials that are either volatile or non-volatile.

In some embodiments according to the present inventive subject matter, including some embodiments that include or do not include any of the features as discussed herein, a composition used to generate tetrahedral lattice elements comprises tetra-functional nuclear moiety precursor compounds and di-functional elongated moiety precursor compounds (and in corresponding aspects, a lattice element comprises [1] plural nuclear moieties that are each bonded to four elongated moieties, and [2] plural elongated moieties that are each bonded to two nuclear moieties.

In some embodiments according to the present inventive subject matter, including some embodiments that include or do not include any of the features as discussed herein, a composition used to generate cubic lattice elements comprises hex-functional nuclear moiety precursor compounds and di-functional elongated moiety precursor compounds (and in corresponding aspects, a lattice element comprises [1] plural nuclear moieties that are each bonded to six elongated moieties, and [2] plural elongated moieties that are each bonded to two nuclear moieties.

In some embodiments according to the present inventive subject matter, including some embodiments that include or do not include any of the features as discussed herein, compositions that comprise at least one lattice structure and operating material are durable and range in properties from rigid to elastomeric, hydrophilic to lipophobic, and adhesive to non-adhesive.

In some embodiments according to the present inventive subject matter, including some embodiments that include or do not include any of the features as discussed herein, the operating material(s) are compatible with at least the larger lattice elements to cause their substantial extension and freedom of motion.

In some embodiments according to the present inventive subject matter, including some embodiments that include or do not include any of the features as discussed herein, the operating material(s) may comprise volatile or reactive fluids. In some embodiments according to the present inventive subject matter, including some embodiments that include or do not include any of the features as discussed herein, the fluid element may comprise one or more magnetic materials (such as iron or nickel nano particles), magnetic mono-pole forming materials (such as aluminum and chrome), one or more conductive materials, one or more electrically active materials, one or more piezoelectric materials, one or more acoustic materials, one or more contractile/expansive materials, one or more heat transfer materials, one or more super-conducting materials, one or more super-fluid materials, one or more optically active materials (such as liquid crystals and/or lens forming materials), one or more hardenable materials, one or more reactive surface reactive or co-reactive) materials, one or more gel-forming materials, one or more adhesive materials, one or more pressure-sensitive materials, one or more adhesive-forming materials, one or more pressure-sensitive adhesive-comprising materials, one or more amphoteric materials, one or more amphophobic materials, one or more combustible materials, one or more flammable materials, and/or one or more fire suppression materials.

Representative examples of types of operating materials include antibiotic materials, drug-releasing materials, therapeutic agents, digestible materials, hydrating materials, transdermal materials, wound-healing materials, artificial skin-forming materials, food-safe materials, anti-bacterial agents, anti-fungal agents, mold repellent agents, agents repellent to insects and other pests, dyes, nano particles (such as functionalized and non-functionalized poly(silsesquioxane)), pigments, and any combinations thereof.

Representative specific examples of materials that can be used as operating materials (and/or that can be included among operating materials) in accordance with the present inventive subject matter include (but are not limited to): volatile and/or non-volatile oils, organic oils, silicone oils, fluorinated oils, organo-metallic fluids, phthalates (e.g., diisononyl phthalate), plasticizers, slip agents, volatile and non-volatile solvents, lubricants, reactive and/or non-reactive fluids, particulates, nano particles, pigments, dyes, surfactants, PDMS, dibutyl sebacate, dibutyl phthalate, hydrocarbon oils, dioctyl adipate, dioctyl sebacate, diethyl phthalate, di-butyl phthalate, di-n-hexyl phthalate, di-n-cetyl phthalate, di-n-decyl phthalate, di-n-dodecyl phthalate, perfluoropolyether oils from Solvay, Daikin and Dupont, plant oils, animal oils, hydrophilic liquids, hygroscopic liquids, polyethylene glycol, low molecular weight polypropylene glycol, liquid biomolecules (or solutions comprising liquid biomolecules), low molecular weight amino acids, polysaccharides, lignins, PTFE, hydrophilic materials, such as poly(ethylene glycol) (PEG), low molecular weight poly(propylene glycol) (PPG), other water absorbing species that may be miscible to water, water, sodium sulfate (Na₂SO₄.10H₂O), NaCl.Na₂SO₄.10H₂O, lauric acid, TME/H₂O (e.g., TME (63%)/H₂O (37%)), Mn(NO₃)₂.6H₂O/MnCl₂.4H₂O (e.g., Mn(NO₃)₂.6H₂O/MnCl₂.4H₂O (4%)), Na₂SiO₃.5H₂O, aluminum, copper, gold, iron, lead, lithium, silver, titanium, zinc, NaNO₃, NaNO₂, NaOH, KNO₃, KOH, NaOH/Na₂CO₃ (e.g., NaOH/Na₂CO₃ (7.2%)), NaCl/NaOH (e.g., NaCl (26.8%)/NaOH), NaCl/KCl/LiCl (e.g., NaCl/KCl (32.4%)/LiCl (32.8%)), NaCl/NaNO₃/Na₂SO₄ (e.g., NaCl (5.7%)/NaNO₃ (85.5%)/Na₂SO₄), NaCl/NaNO₃ (e.g., NaCl/NaNO₃ (5.0%)), NaCl/NaNO₃ (e.g., NaCl (5.0%)/NaNO₃), NaCl/KCl/MgCl₂ (e.g., NaCl (42.5%)/KCl (20.5%)/MgCl₂), KNO₃/NaNO₃ (e.g., KNO₃ (10%)/NaNO₃), KNO₃/KCl (e.g., KNO₃/KCl (4.5%)), KNO₃/KBr/KCl (e.g., KNO₃/KBr (4.7%)/KCl (7.3%)), paraffin 14-carbons, paraffin 15-carbons, paraffin 16-carbons, paraffin 17-carbons, paraffin 18-carbons, paraffin 19-carbons, paraffin 20-carbons, paraffin 21-carbons, paraffin 22-carbons, paraffin 23-carbons, paraffin 24-carbons, paraffin 25-carbons, paraffin 26-carbons, paraffin 27-carbons, paraffin 28-carbons, paraffin 29-carbons, paraffin 30-carbons, paraffin 31-carbons, paraffin 32-carbons, paraffin 33-carbons, paraffin 34-carbons, formic acid, caprilic acid, glycerin, p-lactic acid, methyl palmitate, camphenilone, docasyl bromide, caprylone, phenol, heptadecanone, 1cyclohexylooctadecane, 4-heptadacanone, p-joluidine, cyanamide, methyl eicosanate, 3-heptadecanone, 2-heptadecanone, hydrocinnamic acid, cetyl acid, a-nepthylamine, camphene, O-nitroaniline, 9-heptadecanone, thymol, methyl behenate, diphenyl amine, p-dichlorobenzene, oxolate, hypophosphoric acid, O-xylene dichloride, β-chloroacetic acid, chloroacetic acid, nitro napthalene, trimyristin, heptaudecanoic acid, a-chloroacetic acid, bees wax, glyolic acid, glycolic acid, p-bromophenol, azobenzene, acrylic acid, dinto toluent (2, 4), phenylacetic acid, thiosinamine, bromcamphor, durene, methyl bromobenzoate, alpha napthol, glautaric acid, p-xylene dichloride, catechol, quinone, actanilide, succinic anhydride, benzoic acid, stibene, benzamide, acetic acid, polyethylene glycol 600, capric acid, eladic acid, pentadecanoic acid, tristearin, myristic acid, palmatie acid, stearic acid, acetamide, and methyl fumarate.

At higher molecular weights, PPG is somewhat hydrophobic and not miscible to water. PPG is a common polymer element to a wide range of silane-terminated oligomers. Perfluoropolyether operating materials, employed in some embodiments according to the present inventive subject matter, provide extreme performance over a wide range of temperatures and environmental challenges.

In some embodiments according to the present inventive subject matter, including some embodiments that include or do not include any of the features as discussed herein, free nano particles may be suspended in the operating material(s). In some embodiments according to the present inventive subject matter, including some embodiments that include or do not include any of the features as discussed herein, surfactants may be present in the operating material(s). In some embodiments according to the present inventive subject matter, including some embodiments that include or do not include any of the features as discussed herein, an operating material in accordance with the present inventive subject matter can comprise one or more dyes, one or more pigments, one or more non-functional particles, one or more hydrophobic particles, one or more absorbent materials, one or more quasi-crystalline materials, one or more semi crystalline-containing materials, one or more biphasic materials, one or more triphasic materials, one or more higher-phasic materials, one or more immiscible materials, one or more miscible materials, one or more surfactants, and/or one or more volatile liquids.

As noted above, at least some nuclear moieties in lattice structures in accordance with the present inventive subject matter are bonded to at least three elongated moieties (and in some embodiments of lattice structures in accordance with the present inventive subject matter, at least some nuclear moieties are bonded to four, five or six elongated moieties; in some embodiments of lattice structures in accordance with the present inventive subject matter, at least some nuclear moieties are bonded to seven, eight, nine, ten, eleven, twelve, thirteen, fourteen or more elongated moieties). Correspondingly, at least some nuclear moiety precursor compounds (in compositions suitable for generating lattice structures) have at least three nuclear moiety precursor compound functional moieties (and in some embodiments of compositions used to generate lattice structures, at least some nuclear moiety precursor compounds have at least four, five, six, seven, eight, nine, ten, eleven, twelve, thirteen, fourteen or more nuclear moiety precursor compound functional moieties).

In some embodiments of lattice structures according to the present inventive subject matter, including some embodiments that include or do not include any of the features as discussed herein, at least one of the nuclear moieties can be selected from among metallic groups, organometallic groups, and organosilicon groups (or moieties that comprise metallic groups, organometallic groups, and organosilicon groups).

In some embodiments of lattice structures according to the present inventive subject matter, including some embodiments that include or do not include any of the features as discussed herein, the lattice structure comprises one or more nuclear moieties selected from among tubes, tunnels, cavities, 2D planar crystals, linear planar polymers, hyper lattices (i.e., lattices comprising crystal lattices inside larger crystal lattices), crystal lattices of multiple types, quasi-crystalline domains and semi-crystalline domains. Correspondingly, in some embodiments of compositions suitable for generating lattice structures, including some embodiments that include or do not include any of the features as discussed herein, at least one nuclear moiety precursor compound in the composition is selected from among tubes, tunnels, cavities, 2D planar crystals, linear planar polymers, hyper lattices (i.e., lattices comprising crystal lattices inside larger crystal lattices), crystal lattices of multiple types, quasi-crystalline domains and semi-crystalline domains.

In some embodiments of compositions suitable for generating lattice structures in accordance with the present inventive subject matter, including some embodiments that include or do not include any of the features as discussed herein, at least one nuclear moiety precursor compound and/or at least one elongated moiety precursor compound comprises at least one functional moiety selected from among the group consisting of silanes, silols, oximes, dendrites, polysilsesquioxanes, halogens, compounds with one or more hydrolysable groups, siloxanes, silicones, compounds with one or more acrylic groups, compounds with one or more methacrylic groups, compounds with one or more vinyl groups, isocyanates, amines, amides, active hydrogens, compounds with one or more hydroxyl groups, compounds with one or more sulfur groups, epoxies, organo-metallics, organo-silicones, sulfides, halides, phosphates, organic alcohols, inorganic alcohols, organic acids and inorganic acids. Correspondingly, representative examples of nuclear moiety functional moieties and/or elongated moiety functional moieties include chemical structures that correspond to any of such nuclear moiety precursor compound functional moieties, i.e., chemical structures that correspond to any of silanes, silols, oximes, dendrites, polysilsesquioxanes, halogens, compounds with one or more hydrolysable groups, siloxanes, silicones, compounds with one or more acrylic groups, compounds with one or more methacrylic groups, compounds with one or more vinyl groups, isocyanates, amines, amides, active hydrogens, compounds with one or more hydroxyl groups, compounds with one or more sulfur groups, epoxies, organo-metallics, organo-silicones, sulfides, halides, phosphates, organic alcohols, inorganic alcohols, organic acids and inorganic acids.

Representative examples of materials that are suitable for use as nuclear moiety precursor compounds in accordance with the present inventive subject matter include (but are not limited to) 2-Butanone, O,O′,O″-silanetetrayltetraoxime, 2-Butanone,O,O′,O′-(Methylsilylidyne)Trioxime, Tetramethoxysilane, Tetraethoxysilane, Tetraethyl orthosilicates, Tetrachlorosilane, Trichlorosilane, Tungsten hexachloride, Molybdenum hexacarbonyl, 1,2 Bis(Triethoxysilyl)ethane, and 1,2 Bis(Triethoxysilyl)methane, Molybdenum (VI) oxide bis(pentanedionate, Molybdenum (VI) oxide bis(2,2,6,6-tetramethyl-3,5-heptanedionate, Tungsten (VI) phenoxide, methyltrimethoxysilane, chioromethyltrimethoxysilane, ethyltrimethoxysilane, propyltrimethoxysilane, vinyltrimethoxysilane, methyltriethoxysilane, vinyltriethoxysilane, phenyltriethoxysilane, methyltripropoxysilane, phenyltripropoxysilane, tetramethoxysilane, tetraethoxysilane, tetra-n-propoxysilane, tetra-n-butoxysilane, methyltris(methylethylketoxime)silane, phenyltris(methylethylketoxime)silane, vinyltris(methylethylketoxime)silane, methyltris(methylisobutylketoxime)silane, methyltris(methylpropylketoxime)silane, and tetra(methylethylketoxime)silane. These compounds are available from Gelest (Morrisville, Pa.) and Shanghai Kayi Chemical (Shanghai, China). Correspondingly, representative examples of nuclear moieties in accordance with the present inventive subject matter include (but are not limited to) moieties that correspond to 2-Butanone, O,O′,O″-silanetetrayltetraoxime, 2-Butanone,O,O′,O″-(Methylsilylidyne)Trioxime, Tetramethoxysilane, Tetraethoxysilane, Tetraethyl orthosilicates, Tetrachlorosilane, Trichlorosilane, Tungsten hexachloride, Molybdenum hexacarbonyl, 1,2 Bis(Triethoxysilyl)ethane, and 1,2 Bis(Triethoxysilyl)methane, Molybdenum (VI) oxide bis(pentanedionate, Molybdenum (VI) oxide bis(2,2,6,6-tetramethyl-3,5-heptanedionate, Tungsten (VI) phenoxide, methyltrimethoxysilane, chloromethyltrimethoxysilane, ethyltrimethoxysilane, propyltrimethoxysilane, vinyltrimethoxysilane, methyltriethoxysilane, vinyltriethoxysilane, phenyltriethoxysilane, methyltripropoxysilane, phenyltripropoxysilane, tetramethoxysilane, tetraethoxysilane, tetra-n-propoxysilane, tetra-n-butoxysilane, methyltris(methylethylketoxime)silane, phenyltris(methylethylketoxime)silane, vinyltris(methylethylketoxime)silane, methyltris(methylisobutylketoxime)silane, methyltris(methylpropylketoxime)silane, and tetra(methylethylketoxime)silane.

In some embodiments according to the present inventive subject matter, including some embodiments that include or do not include any of the features as discussed herein, one or more nuclear moiety precursor compound is an essentially compact high functionality species of a suitable functional moiety (or functional moieties) having a molecular radius of about 10 nanometers or less, about 5 nanometers or less and most preferably 3 nanometers or less.

As noted above, at least some elongated moieties in lattice structures in accordance with the present inventive subject matter are bonded to at least two nuclear moieties (and in some embodiments of lattice structures in accordance with the present inventive subject matter, at least some elongated moieties are bonded to three or more nuclear moieties, four or more nuclear moieties or six or more nuclear moieties. Correspondingly, at least some elongated moiety precursor compounds (in compositions suitable for generating lattice structures) have at least two elongated moiety precursor compound functional moieties (and in some embodiments of compositions used to generate lattice structures, at least some elongated moiety precursor compounds have at least three, four, five, six or more elongated moiety precursor compound functional moieties).

Representative examples of materials that are suitable for use as elongated moiety precursor compounds in accordance with the present inventive subject matter include (but are not limited to) silane-terminated polyethers (fluorinated in one or more location or not fluorinated), oxime-terminated polyethers (fluorinated in one or more location or not fluorinated), silane-terminated urethanes (fluorinated in one or more location or not fluorinated), oxime-terminated urethanes (fluorinated in one or more location or not fluorinated), silane-terminated alkyl polymers, silane-terminated aryl polymers, oxime-terminated alkyl polymers, oxime-terminated aryl polymers, hydrophilic materials, such as poly(ethylene glycol) (PEG), low molecular weight poly(propylene glycol) (PPG), and other water absorbing species that may be miscible to water. Correspondingly, representative examples of elongated moieties in accordance with the present inventive subject matter include (but are not limited to) moieties that correspond to silane-terminated polyethers (fluorinated in one or more location or not fluorinated), oxime-terminated polyethers (fluorinated in one or more location or not fluorinated), silane-terminated urethanes (fluorinated in one or more location or not fluorinated), oxime-terminated urethanes (fluorinated in one or more location or not fluorinated), silane-terminated alkyl polymers, silane-terminated aryl polymers, oxime-terminated alkyl polymers, oxime-terminated aryl polymers, hydrophilic materials, such as poly(ethylene glycol) (PEG), low molecular weight poly(propylene glycol) (PPG), and other water absorbing species that may be miscible to water.

At higher molecular weights, PPG is somewhat hydrophobic and not miscible to water. PPG is a common polymer element to a wide range of silane-terminated oligomers. Perfluoropolyether elongation moieties, employed in some embodiments according to the present inventive subject matter, provide extreme performance over a wide range of temperatures and environmental challenges. The molecular weight of these elongation moieties also prescribes the hardness or elasticity of the lattice, as well as the chemical properties.

In some embodiments according to the present inventive subject matter, including some embodiments that include or do not include any of the features as discussed herein, one or more elongated moiety precursor compound is a linear species having a molecular length of about 5 nanometers, or having a molecular length of about 10 nanometers or more.

In some embodiments according to the present inventive subject matter, including some embodiments that include or do not include any of the features as discussed herein, lattice structures in accordance with the present inventive subject matter have geometry or topology selected from among tetrahedral, cubic or of any Bravais, quasi-crystalline or semi-crystalline. In some embodiments according to the present inventive subject matter, including some embodiments that include or do not include any of the features as discussed herein, preferred lattice structures in accordance with the present inventive subject matter have geometry or topology selected from among tetrahedral lattices and cubic lattices.

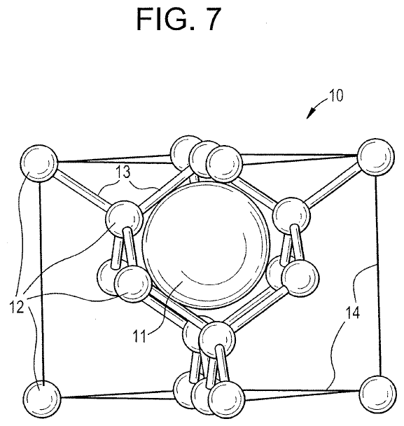

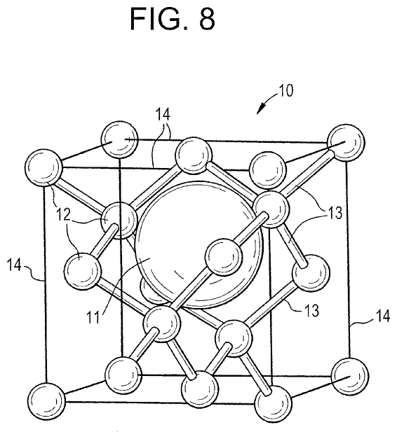

FIGS. 7 and 8 illustrate rotated views of an operating material-filled tetrahedral lattice structure 10 in accordance with the present inventive subject matter, comprising tetra-functional nuclear moieties and di-functional elongated moieties. The large spherical structure 11 represents an operating material filling a cell in the lattice structure (defined by nuclear moieties (spheres 12) and elongated moieties (rods 13). The lines 14 outline a unit cell for a tetrahedral lattice.

FIG. 9 illustrates an operating material-filled cubic lattice structure 20 in accordance with the present inventive subject matter, comprising hex-functional nuclear moieties and di-functional elongated moieties. The large spherical structure 21 represents an operating material filling a cell in the lattice structure (defined by nuclear moieties (spheres 22) and elongated moieties (rods 23).

In many methods of forming organic crystals and many methods of forming inorganic crystal formation, solvents or combinations of solvents are often used to allow elements of the crystal to orient and form bonds, whether covalent, ionic, metallic, hydrogen or Van der walls. Such solvents are typically slowly evaporated after crystallization begins, to encourage further crystallization. When crystallization is complete, solvents are typically removed entirely. In many such cases, without the solvent, or with too much solvent, little crystallization would occur. As discussed below, in the present invention, the operating material(s) assist in, facilitate and/or provide for reactions that generate a lattice structure as described herein. In some cases, one or more solvents can be used in addition to operating material(s).

In some embodiments of methods of making a composition comprising a lattice structure and an operating material in accordance with the present inventive subject matter, including some embodiments that include or do not include any of the features as discussed herein, as with the above-mentioned methods of forming organic crystals and methods of forming inorganic crystals, operating material(s), acting as a solvent, is used at a concentration where crystallization is favored during the bonding of nuclear and elongation elements. In some embodiments of methods of making a composition comprising a lattice structure and an operating material in accordance with the present inventive subject matter, including some embodiments that include or do not include any of the features as discussed herein, the concentration of solvent is sufficiently low to form a lattice structure in which operating material is completely captured inside the lattice, with little or no operating material expressed at any exterior surface of the lattice structure.

In some embodiments of methods of making a composition comprising a lattice structure and an operating material in accordance with the present inventive subject matter, including some embodiments that include or do not include any of the features as discussed herein, concentration of the operating material is in the range of from about 30 percent to about 50 percent per by weight of the entire composition (i.e., the composition for generating a composition comprising a lattice structure and operating material). In some embodiments of methods of making a composition comprising a lattice structure and an operating material in accordance with the present inventive subject matter, including some embodiments that include or do not include any of the features as discussed herein, the concentration of the operating material is chosen with consideration of the length of the elongation moieties (or the respective lengths of the elongation moieties). For example, In some embodiments of methods of making a composition comprising a lattice structure and an operating material in accordance with the present inventive subject matter, including some embodiments that include or do not include any of the features as discussed herein, at least some of the elongation moieties are of a length of about 2500 amu, a weight percentage of operating material in the composition for generating a composition comprising a lattice structure and operating material is in the range of from about 50 percent to about 60 percent by weight, resulting in there being no observable operating material excess at any surface of the lattice structure generated. In some embodiments of methods of making a composition comprising a lattice structure and an operating material in accordance with the present inventive subject matter, including some embodiments that include or do not include any of the features as discussed herein, where a significant proportion of the elongated moieties are branched or network polymers, a weight percentage of operating material in the composition for generating a composition comprising a lattice structure and an operating material is in the range of from only a few percent to only about 15 percent.

In some aspects of the present inventive subject matter, there are provided lattice structures that are able to hold large amounts of operating material, and that are able to hold large amounts of operating material without accumulating significant quantities of excess operating material at any surface of the lattice structure (e.g., with substantially no operating material at any surface of the lattice structure), including lattice structures that are able to hold amounts of operating material that exceed amounts of operating material held in prior art structures, and/or with accumulating less operating material at surfaces of the lattice structure than in such prior art structures.

Without being bound to any particular theory, the applicant believes that the ability of the lattice structures in accordance with the present inventive subject matter to hold larger amounts of operating material, and to do so with lower quantities of operating material accumulating at surfaces of the lattice structure, results at least in part from the very high (higher than that of prior art structures) structural integrity of the lattice structures in accordance with the present inventive subject matter. Moreover, even at the high operating material loads achieved by lattice structures in accordance with the present inventive subject matter, the strength, toughness and abrasion resistance of the operating material-containing lattice structures in accordance with the present inventive subject matter remain high, in some instances nearly equal to similar to compositions that do not comprise an operating material (or that comprise a much lower amount of operating material).

In some embodiments according to the present inventive subject matter, including some embodiments that include or do not include any of the features as discussed herein, there are provided lattice structures that comprise one or more coatings (over part of all of the lattice structure). Such coatings can comprise, e.g., adhesion promoters, surfactants, surface modifiers, and/or monomers that impart useful properties.

Applications for crystalline polymer lattices comprising operating materials cover a very broad range, where they can be superior to conventional coatings and films in cost and/or performance; in terms of low adhesion, they are greatly superior. Anti-fogging, fluid repellent, and self-cleaning coatings, according to the present invention, can be made for windows, sensors, biomedical devices and lenses. The remarkable release properties of some embodiments of the present invention can be useful for molds, transfer films, industrial tapes, labels, die-cut constructions, double-sided tapes, silicone foam or rubber tapes, in-process liner for easier handling of jumbo rolls, transfer to heat sensitive or non-solvent-castable backings, and non-adhesion lab and med devices. Anti-stain, anti-fingerprint coatings of the present invention can have advantages for touch screens, small and large appliance bodies and working surfaces. Ice release on wind turbines, power lines, building drip edges, and aircraft wings can be improved by the present invention. In still other embodiments, the operating material-filled crystal lattices of the present invention can be adhesives, including pressure-sensitive adhesives. Embodiments of the present invention can be hydrophoibic, lipophobic and superhydrophobic.

Conventional fluoro-trimethoxysilanes (Rf-Si(—O—CH₃)₃) typically require either months at ambient temperatures, or 30 minutes at 150 degrees C., to fully moisture cure. R—Si(-oxime)₃ compounds on the other hand moisture cure at ambient temperatures in less than 24 hours, and can accelerate the cure of other silanes.

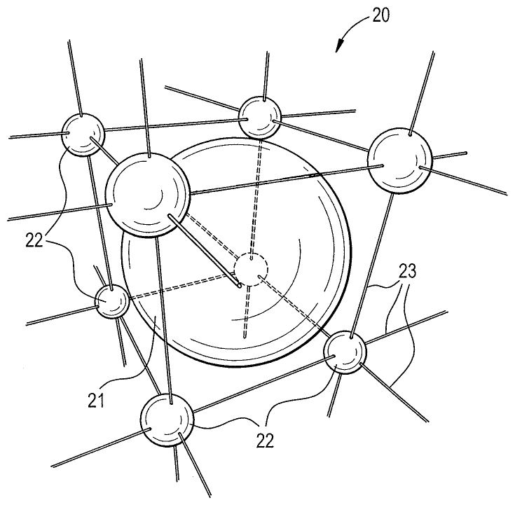

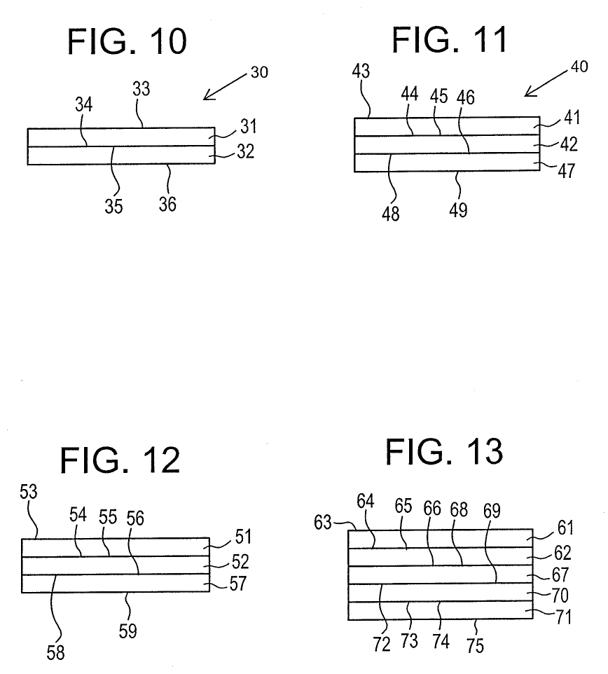

FIG. 10 schematically depicts a structure 30 that comprises a first lattice structure/operating material region 31 and a first additional region 32. The first lattice structure/operating material region 31 comprises at least a first lattice structure (comprising a plurality of nuclear moieties and a plurality of elongated moieties) and at least a first operating material. The first lattice structure/operating material region 31 comprises a first lattice structure/operating material region first surface 33 and a first lattice structure/operating material region second surface 34. The first additional region 32 comprises at least one pressure-sensitive adhesive. The first additional region 32 comprises a first additional region first surface 35 and a first additional region second surface 36. The first lattice structure/operating material region second surface 34 is on the first additional region first surface 35.

FIG. 11 schematically depicts a structure 40 that comprises a first lattice structure/operating material region 41, a first additional region 42 and a first substrate 47. The first lattice structure/operating material region 41 comprises at least a first lattice structure (comprising a plurality of nuclear moieties and a plurality of elongated moieties) and at least a first operating material. The first lattice structure/operating material region 41 comprises a first lattice structure/operating material region first surface 43 and a first lattice structure/operating material region second surface 44. The first additional region 42 comprises at least one pressure-sensitive adhesive. The first additional region 42 comprises a first additional region first surface 45 and a first additional region second surface 46. The first substrate 47 comprises a first substrate first surface 48 and a first substrate second surface 49. The first lattice structure/operating material region second surface 44 is on the first additional region first surface 45, and the first additional region second surface 46 is on the first substrate first surface 48. The first substrate comprises at least one element selected from among the group consisting of a window, a sensor, a biomedical device, a lens, a mold, a transfer film, an industrial tape, a label, a die-cut construction, double-sided tape, silicone foam, rubber tape, an in-process liner for easier handling of jumbo rolls, a heat sensitive or non-solvent-castable backing, a non-adhesion lab device, a medical device, a touch screen, an appliance body, a working surface, a wind turbine, a power line, a building drip edge, a fishing line, and an aircraft wing.

FIG. 12 schematically depicts a structure 50 that comprises a first lattice structure/operating material region 51, a first additional region 52 and a releasable film 57. The first lattice structure/operating material region 51 comprises at least a first lattice structure (comprising a plurality of nuclear moieties and a plurality of elongated moieties) and at least a first operating material. The first lattice structure/operating material region 51 comprises a first lattice structure/operating material region first surface 53 and a first lattice structure/operating material region second surface 54. The first additional region 52 comprises at least one pressure-sensitive adhesive. The first additional region 52 comprises a first additional region first surface 55 and a first additional region second surface 56. The first releasable film 57 comprises a first releasable film first surface 58 and a first releasable film second surface 59. The first lattice structure/operating material region second surface 54 is on the first additional region first surface 55, and the first additional region second surface 56 is on the first releasable film first surface 58.

FIG. 13 schematically depicts a structure 60 that comprises a first lattice structure/operating material region 61, a first additional region 62, a releasable film 67, a second additional region 70 and a second lattice structure/operating material region 71. The first lattice structure/operating material region 61 comprises at least a first lattice structure (comprising a plurality of nuclear moieties and a plurality of elongated moieties) and at least a first operating material. The first lattice structure/operating material region 61 comprises a first lattice structure/operating material region first surface 63 and a first lattice structure/operating material region second surface 64. The first additional region 62 comprises at least one pressure-sensitive adhesive. The first additional region 62 comprises a first additional region first surface 65 and a first additional region second surface 66. The first releasable film 67 comprises a first releasable film first surface 68 and a first releasable film second surface 69.

The second additional region 70 comprises at least one pressure-sensitive adhesive. The second additional region 70 comprises a second additional region first surface 72 and a second additional region second surface 73.

The second lattice structure/operating material region 71 comprises at least a second lattice structure (comprising a plurality of nuclear moieties and a plurality of elongated moieties) and at least a second operating material. The second lattice structure/operating material region 71 comprises a second lattice structure/operating material region first surface 74 and a second lattice structure/operating material region second surface 75.

The first lattice structure/operating material region second surface 64 is on the first additional region first surface 65, the first additional region second surface 66 is on the first releasable film first surface 68, the first releasable film second surface 69 is on the second additional region first surface 72, and the second additional region second surface 73 is on the second lattice structure/operating material region first surface 74.

### EXAMPLES

Properties of the operating material-containing lattice surfaces are affected by properties of the lattice structures and the operating material(s).

### Example 1

In Example 1, a stoichiometric mixture comprising [1] 2500 amu silane terminated polypropylene glycol (as elongated moiety precursor compounds), [2] silanetetrayltetraoxime (as nuclear moiety precursor compounds), and [3] operating material comprising 50 weight percent (w/w based on the total mixture) of diisononyl phthalate was formed. One mm thick films on glass plates were cured at 70° C. and 40 percent RH for 48 hours to form an operating material-containing lattice structure composition comprising a lattice structure with operating material held in cells of the lattice structure. Surfaces of the operating material-containing lattice structure were highly repellent to water and ice both before and after abrasion. Contact angles to water (of the operating material-containing lattice structure) were 85 to 95 degrees, and the slip angle to water (of the operating material-containing lattice structure) was 10 to 15 degrees. Adhesion to ice (of the operating material-containing lattice structure) was 0.5 to 4 KPa. Abrasion (of the operating material-containing lattice structure) was carried out on a 3000 grit belt at 2 inches per second with one kilogram pressure for 2000 inches of linear travel. This operating material-containing lattice structure was of course not resistant to organic solvents.

### Example 2

In Example 2, a stoichiometric mixture comprising [1] 2000 amu silane-terminated perfluoropolyether (as elongated moiety precursor compounds), [2] silanetetrayltetraoxime (as nuclear moiety precursor compounds), and [3] operating material comprising 50 weight percent (w/w based on the total mixture) of 4000 amu periluoropolyether was formed. The mixture further comprised 10 weight percent of Vertrel™ MCA plus that evaporated during the cure. One mm thick films on glass plates were cured at 70° C. and 40 percent RH for 48 hours to form an operating material-containing lattice structure composition comprising a lattice structure with operating material held in cells of the lattice structure. Surfaces of the operating material-containing lattice structure were highly repellent to water and ice and a wide variety of organic solvents and oils both before and after abrasion. Contact angles to water (of the operating material-containing lattice structure) were 100 to 114, and contact angles to n-hexadecane (of the operating material-containing lattice structure) were 63 to 68 degrees. The slip angle to water (of the operating material-containing lattice structure) was 3 to 5 degrees. Adhesion to ice (of the operating material-containing lattice structure) was 0.2 to 4 KPa. Abrasion (of the operating material-containing lattice structure) was carried out on a 3000 grit belt at 2 inches per second with one kilogram pressure for 2000 inches of linear travel.

1. A composition, comprising:
at least a first lattice structure; and
operating material comprising at least a first operating material, the first lattice structure comprising a plurality of nuclear moieties and a plurality of elongated moieties,
at least some of said nuclear moieties chemically bonded to at least three of said elongated moieties,
at least some of said elongated moieties chemically bonded to at least two of said nuclear moieties.

2-3. (canceled)

4. A composition as recited in claim 1, wherein at least some of said nuclear moieties correspond to at least one compound selected from among the group of compounds consisting of 2-Butanone, O,O′,O″-silanetetrayltetraoxime, 2-Butanone,O,O′, O″-(Methylsilylidyne)Trioxime, Tetramethoxysilane, Tetraethoxysilane, Tetraethyl orthosilicates, Tetrachlorosilane, Trichlorosilane, Tungsten hexachloride, Molybdenum hexacarbonyl, 1,2 Bis(Triethoxysilyl)ethane, and 1,2 Bis(Triethoxysilyl)methane, Molybdenum (VI) oxide bis(pentanedionate, Molybdenum (VI) oxide bis(2,2,6,6-tetramethyl-3,5-heptanedionate, Tungsten (VI) phenoxide, methyltrimethoxysilane, chloromethyltrimethoxysilane, ethyltrimethoxysilane, propyltrimethoxysilane, vinyltrimethoxysilane, methyltriethoxysilane, vinyltriethoxysilane, phenyltriethoxysilane, methyltripropoxysilane, phenyltripropoxysilane, tetramethoxysilane, tetraethoxysilane, tetra-n-propoxysilane, tetra-n-butoxysilane, methyltris(methylethylketoxime)silane, phenyltris(methylethylketoxime)silane, vinyltris(methylethylketoxime)silane, methyltris(methylisobutylketoxime)silane, methyltris(methylpropylketoxime)silane, and tetra(methylethylketoxime)silane.

5. A composition as recited in claim 4, wherein at least some of said elongated moieties correspond to at least one compound selected from among the group of compounds consisting of optionally-fluorinated silane-terminated polyethers, optionally-fluorinated oxime-terminated polyethers, optionally-fluorinated silane-terminated urethanes, optionally-fluorinated oxime-terminated urethanes, silane-terminated alkyl polymers, silane-terminated aryl polymers, oxime-terminated alkyl polymers, oxime-terminated aryl polymers, and hydrophilic materials.

6. A composition as recited in claim 1, wherein at least some of said elongated moieties correspond to at least one compound selected from among the group of compounds consisting of optionally-fluorinated silane-terminated polyethers, optionally-fluorinated oxime-terminated polyethers, optionally-fluorinated silane-terminated urethanes, optionally-fluorinated oxime-terminated urethanes, silane-terminated alkyl polymers, silane-terminated aryl polymers, oxime-terminated alkyl polymers, oxime-terminated aryl polymers, and hydrophilic materials.

7-9. (canceled)

10. A composition as recited in claim 1, wherein at least some of the operating material is in respective wells in the first lattice structure.

11. A composition as recited in claim 1, wherein the first operating material comprises at least one compound selected from among the group of compounds consisting of volatile and/or non-volatile oils, organic oils, silicone oils, fluorinated oils, organo-metallic fluids, phthalates, plasticizers, slip agents, volatile and non-volatile solvents, lubricants, reactive and/or non-reactive fluids, particulates, nano particles, pigments, dyes, surfactants, PDMS, dibutyl sebacate, dibutyl phthalate, hydrocarbon oils, dioctyl adipate, dioctyl sebacate, diethyl phthalate, di-butyl phthalate, di-n-hexyl phthalate, di-n-cctyl phthalate, di-n-decyl phthalate, di-n-dodecyl phthalate, perfluoropolyether oils from Solvay, Daikin and Dupont, plant oils, animal oils, hydrophilic liquids, hygroscopic liquids, polyethylene glycol, low molecular weight polypropylene glycol, liquid biomolecules, low molecular weight amino acids, polysaccharides, lignins, PTFE, hydrophilic materials, water, sodium sulfate (Na₂SO₄.10H₂O), NaCl.Na₂SO₄.10H₂O, lauric acid, TME/H₂O (e.g., TME (63%)/H₂O (37%)), Mn(NO₃)₂.6H₂O/MnCl₂.4H₂O (e.g., Mn(NO₃)₂.6H₂O/MnCl₂.4H₂O (4%)), Na₂SiO₃.5H₂O, aluminum, copper, gold, iron, lead, lithium, silver, titanium, zinc, NaNO₃, NaNO₂, NaOH, KNO₃, KOH, NaOH/Na₂CO₃ (e.g., NaOH/Na₂CO₃ (7.2%)), NaCl/NaOH (e.g., NaCl (26.8%)/NaOH), NaCl/KCl/LiCl (e.g., NaCl/KCl (32.4%)/LiCl (32.8%)), NaCl/NaNO₃/Na₂SO₄ (e.g., NaCl (5.7%)/NaNO₃ (85.5%)/Na₂SO₄), NaCl/NaNO₃ (e.g., NaCl/NaNO₃ (5.0%)), NaCl/NaNO₃ (e.g., NaCl (5.0%) /NaNO₃), NaCl/KCl/MgCl₂ (e.g., NaCl (42.5%)/KCl (20.5%)/MgCl₂), KNO₃/NaNO₃ (e.g., KNO₃ (10%)/NaNO₃), KNO₃/KCl (e.g., KNO₃/KCl (4.5%)), KNO₃/KBr/KCl (e.g., KNO₃/KBr (4.7%)/KCl (7.3%)), paraffin 14-carbons, paraffin 15-carbons, paraffin 16-carbons, paraffin 17-carbons, paraffin 18-carbons, paraffin 19-carbons, paraffin 20-carbons, paraffin 21-carbons, paraffin 22-carbons, paraffin 23-carbons, paraffin 24-carbons, paraffin 25-carbons, paraffin 26-carbons, paraffin 27-carbons, paraffin 28-carbons, paraffin 29-carbons, paraffin 30-carbons, paraffin 31-carbons, paraffin 32-carbons, paraffin 33-carbons, paraffin 34-carbons, formic acid, caprilic acid, glycerin, p-lactic acid, methyl palmitate, camphenilone, docasyl bromide, caprylone, phenol, heptadecanone, 1cyclohexylooctadecane, 4-heptadacanone, p-joluidine, cyanamide, methyl eicosanate, 3-heptadecanone, 2-heptadecanone, hydrocinnamic acid, cetyl acid, a-nepthylamine, camphene, O-nitroaniline, 9-heptadecanone, thymol, methyl behenate, diphenyl amine, p-dichlorobenzene, oxolate, hypophosphoric acid, O-xylene dichloride, l3-chloroacetic acid, chloroacetic acid, nitro napthalene, trimyristin, heptaudecanoic acid, a-chloroacetic acid, bees wax, glyolic acid, glycolic acid, p-bromophenol, azobenzene, acrylic acid, dinto toluent (2, 4), phenylacetic acid, thiosinamine, bromcamphor, durene, methyl bromobenzoate, alpha napthol, glautaric acid, p-xylene dichloride, catechol, quinone, actanilide, succinic anhydride, benzoic acid, stibene, benzamide, acetic acid, polyethylene glycol 600, capric acid, eladic acid, pentadecanoic acid, tristearin, myristic acid, palmatic acid, stearic acid, acetamide, and methyl fumarate.

12. (canceled)

13. A composition as recited in claim 1, wherein the operating material accounts for at least 20 percent by weight of said composition.

14. A composition as recited in claim 1, wherein the operating material accounts for at least 30 percent by weight of said composition.

15. A composition as recited in claim 1, wherein the operating material accounts for at least 50 percent by weight of said composition.

16-22. (canceled)

23. A composition, comprising:
a plurality of nuclear moiety precursor compounds;
a plurality of elongated moiety precursor compounds; and
at least a first operating material,
the plurality of nuclear moiety precursor compounds comprising at least a first nuclear moiety precursor compound,
the plurality of elongated moiety precursor compounds comprising at least a first elongated moiety precursor compound,
the first nuclear moiety precursor compound selected from among the group of compounds consisting of 2-Butanone, O,O′,O″-silanetetrayltetraoxime, 2-Butanone,O,O′,O″-(Methylsilylidyne)Trioxime, Tetramethoxysilane, Tetraethoxysilane, Tetraethyl orthosilicates, Tetrachlorosilane, Trichlorosilane, Tungsten hexachloride, Molybdenum hexacarbonyl, 1,2 Bis(Triethoxysilyl)ethane, and 1,2 Bis(Triethoxysilyl)methane, Molybdenum (VI) oxide bis(pentanedionate, Molybdenum (VI) oxide bis(2,2,6,6-tetramethyl-3,5-heptanedionate, Tungsten (VI) phenoxide, methyltrimethoxysilane, chloromethyltrimethoxysilane, ethyltrimethoxysilane, propyltrimethoxysilane, vinyltrimethoxysilane, methyltriethoxysilane, vinyltriethoxysilane, phenyltriethoxysilane, methyltripropoxysilane, phenyltripropoxysilane, tetramethoxysilane, tetraethoxysilane, tetra-n-propoxysilane, tetra-n-butoxysilane, methyltris(methylethylketoxime)silane, phenyltris(methylethylketoxime)silane, vinyltris(methylethylketoxime)silane, methyltris(methylisobutylketoxime)silane, methyltris(methylpropylketoxime)silane, and tetra(methylethylketoxime)silane, the first elongated moiety precursor compound selected from among the group of compounds consisting of optionally-fluorinated silane-terminated polyethers, optionally-fluorinated oxime-terminated polyethers, optionally-fluorinated silane-terminated urethanes, optionally-fluorinated oxime-terminated urethanes, silane-terminated alkyl polymers, silane-terminated aryl polymers, oxime-terminated alkyl polymers, oxime-terminated aryl polymers, and hydrophilic materials, the first operating material comprising at least one compound selected from among the group of compounds consisting of volatile and/or non-volatile oils, organic oils, silicone oils, fluorinated oils, organo-metallic fluids, phthalates, plasticizers, slip agents, volatile and non-volatile solvents, lubricants, reactive and/or non-reactive fluids, particulates, nano particles, pigments, dyes, surfactants, PDMS, dibutyl sebacate, dibutyl phthalate, hydrocarbon oils, dioctyl adipate, dioctyl sebacate, diethyl phthalate, di-butyl phthalate, di-n-hexyl phthalate, di-n-cctyl phthalate, di-n-decyl phthalate, di-n-dodecyl phthalate, perfluoropolyether oils from Solvay, Daikin and Dupont, plant oils, animal oils, hydrophilic liquids, hygroscopic liquids, polyethylene glycol, low molecular weight polypropylene glycol, liquid biomolecules, low molecular weight amino acids, polysaccharides, lignins, PTFE, hydrophilic materials, water, sodium sulfate (Na₂SO₄.10H₂O), NaCl.Na₂SO₄.10H₂O, lauric acid, TME/H₂O (e.g., TME (63%)/H₂O (37%)), Mn(NO₃)₂.6H₂O/MnCl₂.4H₂O (e.g., Mn(NO₃)₂.6H₂O/MnCl₂.4H₂O (4%)), Na₂SiO₃.5H₂O, aluminum, copper, gold, iron, lead, lithium, silver, titanium, zinc, NaNO₃, NaNO₂, NaOH, K NO₃, KOH, NaOH/Na₂CO₃ (e.g., NaOH/Na₂CO₃ (7.2%)), NaCl/NaOH (e.g., NaCl (26.8%)/NaOH), NaCl/KCl/LiCl (e.g., NaCl/KCl (32.4%)/LiCl (32.8%)), NaCl/NaNO₃/Na₂SO₄ (e.g., NaCl (5.7%)/NaNO₃ (85.5%)/Na₂SO₄), NaCl/NaNO₃ (e.g., NaCl/NaNO₃ (5.0%)), NaCl/NaNO₃ (e.g., NaCl (5.0%) /NaNO₃), NaCl/KCl/MgCl₂ (e.g., NaCl (42.5%)/KCl (20.5%)/MgCl₂), KNO₃/NaNO₃ (e.g., KNO₃ (10%)/NaNO₃), KNO₃/KCl (e.g., KNO₃/KCl (4.5%)), KNO₃/KBr/KCl (e.g., KNO₃/KBr (4.7%)/KCl (7.3%)), paraffin 14-carbons, paraffin 15-carbons, paraffin 16-carbons, paraffin 17-carbons, paraffin 18-carbons, paraffin 19-carbons, paraffin 20-carbons, paraffin 21-carbons, paraffin 22-carbons, paraffin 23-carbons, paraffin 24-carbons, paraffin 25-carbons, paraffin 26-carbons, paraffin 27-carbons, paraffin 28-carbons, paraffin 29-carbons, paraffin 30-carbons, paraffin 31-carbons, paraffin 32-carbons, paraffin 33-carbons, paraffin 34-carbons, formic acid, caprilic acid, glycerin, p-lactic acid, methyl palmitate, camphenilone, docasyl bromide, caprylone, phenol, heptadecanone, 1cyclohexylooctadecane, 4-heptadacanone, p-joluidine, cyanamide, methyl eicosanate, 3-heptadecanone, 2-heptadecanone, hydrocinnamic acid, cetyl acid, a-nepthylamine, camphene, O-nitroaniline, 9-heptadecanone, thymol, methyl behenate, diphenyl amine, p-dichlorobenzene, oxolate, hypophosphoric acid, O-xylene dichloride, β-chloroacetic acid, chloroacetic acid, nitro napthalene, trimyristin, heptaudecanoic acid, a-chloroacetic acid, bees wax, glyolic acid, glycolic acid, p-bromophenol, azobenzene, acrylic acid, dinto toluent (2, 4), phenylacetic acid, thiosinamine, bromcamphor, durene, methyl bromobenzoate, alpha napthol, glautaric acid, p-xylene dichloride, catechol, quinone, actanilide, succinic anhydride, benzoic acid, stibene, benzamide, acetic acid, polyethylene glycol 600, capric acid, eladic acid, pentadecanoic acid, tristearin, myristic acid, palmatic acid, stearic acid, acetamide, and methyl fumarate.

24-25. (canceled)

26. A composition as recited in claim 23, wherein the composition comprises at least a first solvent.

27. A composition as recited in claim 23, wherein the first operating material accounts for at least 20 percent by weight of said composition.

28. A composition as recited in claim 23, wherein the first operating material accounts for at least 30 percent by weight of said composition.

29. A composition as recited in claim 23, wherein the first operating material accounts for at least 50 percent by weight of said composition.

30. A method, comprising:
supplying at least [1] nuclear moiety precursor compounds, [2] elongated moiety precursor compounds, and [3] operating material compounds to a space; and
removing from the space a composition comprising at least a first lattice structure and a plurality of said operating material compounds, the first lattice structure comprising a plurality of nuclear moieties and a plurality of elongated moieties,
each of the plurality of nuclear moieties corresponding to a respective one of the nuclear moiety precursor compounds,
each of the plurality of elongated moieties corresponding to a respective one of the elongated moiety precursor compounds,
each of at least some of the plurality of nuclear moieties chemically bonded to at least three of the plurality of elongated moieties,
each of at least some of the plurality of elongated moieties chemically bonded to at least two of the plurality of nuclear moieties,
the first lattice structure defining a plurality of respective cells.

31. A method as recited in claim 30, wherein at least some of said nuclear moiety precursor compounds are selected from among the group of compounds consisting of 2-Butanone, O,O′,O″-silanetetrayltetraoxime, 2-Butanone,O,O′, O″-(Methylsilylidyne)Trioxime, Tetramethoxysilane, Tetraethoxysilane, Tetraethyl orthosilicates, Tetrachlorosilane, Trichlorosilane, Tungsten hexachloride, Molybdenum hexacarbonyl, 1,2 Bis(Triethoxysilyl)ethane, and 1,2 Bis(Triethoxysilyl)methane, Molybdenum (VI) oxide bis(pentanedionate, Molybdenum (VI) oxide bis(2,2,6,6-tetramethyl-3,5-heptanedionate, Tungsten (VI) phenoxide, methyltrimethoxysilane, chioromethyltrimethoxysilane, ethyltrimethoxysilane, propyltrimethoxysilane, vinyltrimethoxysilane, methyltriethoxysilane, vinyltriethoxysilane, phenyltriethoxysilane, methyltripropoxysilane, phenyltripropoxysilane, tetramethoxysilane, tetraethoxysilane, tetra-n-propoxysilane, tetra-n-butoxysilane, methyltris(methylethylketoxime)silane, phenyltris(methylethylketoxime)silane, vinyltris(methylethylketoxime)silane, methyltris(methylisobutylketoxime)silane, methyltris(methylpropylketoxime)silane, and tetra(methylethylketoxime)silane.

32. A method as recited in claim 31, wherein at least some of said elongated moiety precursor compounds are selected from among the group of compounds consisting of optionally-fluorinated silane-terminated polyethers, optionally-fluorinated oxime-terminated polyethers, optionally-fluorinated silane-terminated urethanes, optionally-fluorinated oxime-terminated urethanes, silane-terminated alkyl polymers, silane-terminated aryl polymers, oxime-terminated alkyl polymers, oxime-terminated aryl polymers, and hydrophilic materials.

33. A method as recited in claim 30, wherein at least some of said elongated moiety precursor compounds are selected from among the group of compounds consisting of optionally-fluorinated silane-terminated polyethers, optionally-fluorinated oxime-terminated polyethers, optionally-fluorinated silane-terminated urethanes, optionally-fluorinated oxime-terminated urethanes, silane-terminated alkyl polymers, silane-terminated aryl polymers, oxime-terminated alkyl polymers, oxime-terminated aryl polymers, and hydrophilic materials.

34-38. (canceled)

39. A method as recited in claim 30, wherein the operating material compounds comprise at least one compound selected from among the group of compounds consisting of volatile and/or non-volatile oils, organic oils, silicone oils, fluorinated oils, organo-metallic fluids, phthalates, plasticizers, slip agents, volatile and non-volatile solvents, lubricants, reactive and/or non-reactive fluids, particulates, nano particles, pigments, dyes, surfactants, PDMS, dibutyl sebacate, dibutyl phthalate, hydrocarbon oils, dioctyl adipate, dioctyl sebacate, diethyl phthalate, di-butyl phthalate, di-n-hexyl phthalate, di-n-cctyl phthalate, di-n-decyl phthalate, di-n-dodecyl phthalate, perfluoropolyether oils from Solvay, Daikin and Dupont, plant oils, animal oils, hydrophilic liquids, hygroscopic liquids, polyethylene glycol, low molecular weight polypropylene glycol, liquid biomolecules, low molecular weight amino acids, polysaccharides, lignins, PTFE, hydrophilic materials, water, sodium sulfate (Na₂SO₄.10H₂O), NaCl.Na₂SO₄.10H₂O, lauric acid, TME/H₂O (e.g., TME (63%)/H₂O (37%)), Mn(NO₃)₂.6H₂O/MnCl₂.4H₂O (e.g., Mn(NO₃)₂.6H₂O/MnCl₂.4H₂O (4%)), Na₂SiO₃.5H₂O, aluminum, copper, gold, iron, lead, lithium, silver, titanium, zinc, NaNO₃, NaNO₂, NaOH, KNO₃, KOH, NaOH/Na₂CO₃ (e.g., NaOH/Na₂CO₃ (7.2%)), NaCl/NaOH (e.g., NaCl (26.8%)/NaOH), NaCl/KCl/LiCl (e.g., NaCl/KCl (32.4%)/LiCl (32.8%)), NaCl/NaNO₃/Na₂SO₄ (e.g., NaCl (5.7%)/NaNO₃ (85.5%)/Na₂SO₄), NaCl/NaNO₃ (e.g., NaCl/NaNO₃ (5.0%)), NaCl/NaNO₃ (e.g., NaCl (5.0%) /NaNO₃), NaCl/KCl/MgCl₂ (e.g., NaCl (42.5%)/KCl (20.5%)/MgCl₂), KNO₃/NaNO₃ (e.g., KNO₃ (10%)/NaNO₃), KNO₃/KCl (e.g., KNO₃/KCl (4.5%)), KNO₃/KBr/KCl (e.g., KNO₃/KBr (4.7%)/KCl (7.3%)), paraffin 14-carbons, paraffin 15-carbons, paraffin 16-carbons, paraffin 17-carbons, paraffin 18-carbons, paraffin 19-carbons, paraffin 20-carbons, paraffin 21-carbons, paraffin 22-carbons, paraffin 23-carbons, paraffin 24-carbons, paraffin 25-carbons, paraffin 26-carbons, paraffin 27-carbons, paraffin 28-carbons, paraffin 29-carbons, paraffin 30-carbons, paraffin 31-carbons, paraffin 32-carbons, paraffin 33-carbons, paraffin 34-carbons, formic acid, caprilic acid, glycerin, p-lactic acid, methyl palmitate, camphenilone, docasyl bromide, caprylone, phenol, heptadecanone, 1cyclohexylooctadecane, 4-heptadacanone, p-joluidine, cyanamide, methyl eicosanate, 3-heptadecanone, 2-heptadecanone, hydrocinnamic acid, cetyl acid, a-nepthylamine, camphene, O-nitroaniline, 9-heptadecanone, thymol, methyl behenate, diphenyl amine, p-dichlorobenzene, oxolate, hypophosphoric acid, O-xylene dichloride, β-chloroacetic acid, chloroacetic acid, nitro napthalene, trimyristin, heptaudecanoic acid, a-chloroacetic acid, bees wax, glyolic acid, glycolic acid, p-bromophenol, azobenzene, acrylic acid, dinto toluent (2, 4), phenylacetic acid, thiosinamine, bromcamphor, durene, methyl bromobenzoate, alpha napthol, glautaric acid, p-xylene dichloride, catechol, quinone, actanilide, succinic anhydride, benzoic acid, stibene, benzamide, acetic acid, polyethylene glycol 600, capric acid, eladic acid, pentadecanoic acid, tristearin, myristic acid, palmatic acid, stearic acid, acetamide, and methyl fumarate.

40. (canceled)

41. A method as recited in claim 39, wherein the operating material compounds account for at least 20 percent by weight of said composition comprising at least a first lattice structure and a plurality of said operating material compounds.

42. A method as recited in claim 39, wherein the operating material compounds account for at least 30 percent by weight of said composition comprising at least a first lattice structure and a plurality of said operating material compounds.

43. A method as recited in claim 39, wherein the operating material compounds account for at least 50 percent by weight of said composition comprising at least a first lattice structure and a plurality of said operating material compounds.

44-45. (canceled)

46. A composition, comprising:
a plurality of nuclear moiety precursor compounds; and
a plurality of elongated moiety precursor compounds,
the plurality of nuclear moiety precursor compounds comprising at least a first nuclear moiety precursor compound,
the plurality of elongated moiety precursor compounds comprising at least a first elongated moiety precursor compound,
the first nuclear moiety precursor compound selected from among the group of compounds consisting of 2-Butanone, O,O′,O″-silanetetrayltetraoxime, 2-Butanone,O,O′,O″-(Methylsilylidyne)Trioxime, Tetramethoxysilane, Tetraethoxysilane, Tetraethyl orthosilicates, Tetrachlorosilane, Trichlorosilane, Tungsten hexachloride, Molybdenum hexacarbonyl, 1,2 Bis(Triethoxysilyl)ethane, and 1,2 Bis(Triethoxysilyl)methane, Molybdenum (VI) oxide bis(pentanedionate, Molybdenum (VI) oxide bis(2,2,6,6-tetramethyl-3,5-heptanedionate, Tungsten (VI) phenoxide, methyltrimethoxysilane, chloromethyltrimethoxysilane, ethyltrimethoxysilane, propyltrimethoxysilane, vinyltrimethoxysilane, methyltriethoxysilane, vinyltriethoxysilane, phenyltriethoxysilane, methyltripropoxysilane, phenyltripropoxysilane, tetramethoxysilane, tetraethoxysilane, tetra-n-propoxysilane, tetra-n-butoxysilane, methyltris(methylethylketoxime)silane, phenyltris(methylethylketoxime)silane, vinyltris(methylethylketoxime)silane, methyltris(methylisobutylketoxime)silane, methyltris(methylpropylketoxime)silane, and tetra(methylethylketoxime)silane, the first elongated moiety precursor compound selected from among the group of compounds consisting of optionally-fluorinated silane-terminated polyethers, optionally-fluorinated oxime-terminated polyethers, optionally-fluorinated silane-terminated urethanes, optionally-fluorinated oxime-terminated urethanes, silane-terminated alkyl polymers, silane-terminated aryl polymers, oxime-terminated alkyl polymers, oxime-terminated aryl polymers, and hydrophilic materials.

47. (canceled)

48. A composition as recited in claim 46, wherein the composition comprises at least a first solvent.

49. A composition as recited in claim 46, wherein the first operating material accounts for at least 20 percent by weight of said composition.

50. A composition as recited in claim 46, wherein the first operating material accounts for at least 30 percent by weight of said composition.

51. A composition as recited in claim 46, wherein the first operating material accounts for at least 50 percent by weight of said composition.

52-74. (canceled)
